(19) United States
(12) Patent Application Publication
(10) Pub. No.: US 2025/0010524 A1
(43) Pub. Date: Jan. 9, 2025

(54) STRETCHING APPARATUS

(71) Applicant: THE JAPAN STEEL WORKS, LTD., Shinagawa-ku, Tokyo (JP)

(72) Inventors: Kenichiro YAGI, Tokyo (JP); Taiji MINAMOTO, Tokyo (JP)

(21) Appl. No.: 18/711,589

(22) PCT Filed: Jun. 22, 2022
(86) PCT No.: PCT/JP2022/024939

§ 371 Date: May 18, 2024

(30) Foreign Application Priority Data
Nov. 24, 2021 (JP) 2021-190023

(51) Int. Cl. B29C 35/02; B29C 35/00; B29C 55/02

(52) U.S. Cl. CPC B29C 35/025; B29C 35/002; B29C 55/02

(57) ABSTRACT

A stretching apparatus includes a heat treatment unit 12 configured to perform a heat treatment to a film 8 to be stretched. The heat treatment unit 12 includes a chamber 31, an air supply unit 32 configured to supply air into the chamber 31, an exhaust unit 33 configured to exhaust air from the chamber 31, a pressure measuring unit 34 configured to measure a pressure inside the chamber 31, and a control unit 35. The exhaust unit 33 has an exhaust port 51 provided in the chamber 31 and an exhaust blower 54 capable of exhausting air through the exhaust port 51. The control unit 35 controls the pressure inside the chamber 31 by adjusting an air volume of the exhaust blower 54 based on the pressure measured by the pressure measuring unit 34.

### TECHNICAL FIELD

The present invention relates to a stretching apparatus.

### BACKGROUND ART

Films can be stretched by use of a stretching apparatus. The stretching apparatus configured to stretch a thermoplastic resin film includes a heat treatment unit for performing heat treatment to the film, and stretches the film while performing heat treatment thereto.

For example, Japanese Unexamined Patent Application Publication No. 2014-180779 (Patent Document 1) discloses a technique related to a stretching apparatus.

### RELATED ART DOCUMENTS

### Patent Documents

Patent Document 1: Japanese Unexamined Patent Application Publication No. 2014-180779

### SUMMARY OF THE INVENTION

### Problems to be Solved by the Invention

When a film to be subjected to the stretching process is conveyed into a heat treatment unit of a stretching apparatus, an accompanying flow may be generated as the film advances. If the accompanying flow is generated, the temperature in the vicinity of the film becomes more likely to fluctuate, which may result in non-uniform properties of the film after the stretching process.

Also, the cold outside air flows into the heat treatment unit through an inlet and outlet of the heat treatment unit of the stretching apparatus in some cases, and this makes it difficult to control the temperature inside the heat treatment unit, which may result in non-uniform properties of the film after the stretching process.

In addition, there is the possibility that components contained in a film may be volatilized when the heat treatment to the film is performed in the heat treatment unit of the stretching apparatus, and it is desirable to prevent the volatile components from flowing out through the inlet and outlet of the heat treatment unit of the stretching apparatus depending on the type of the volatile components.

These are the problems related to the movement of gas inside the heat treatment unit of the stretching apparatus or the movement of gas between the inside and outside of the heat treatment unit, and it is desirable to solve or suppress these problems.

Other objects and novel features will become apparent from the description of this specification and the accompanying drawings.

### Means for Solving the Problems

According to an embodiment, a stretching apparatus of a thermoplastic resin film includes a heat treatment unit configured to perform a heat treatment to the thermoplastic resin film. The heat treatment unit includes a chamber, an air supply unit configured to supply air into the chamber, an exhaust unit configured to exhaust air from the chamber, a pressure measuring unit configured to measure a pressure inside the chamber, and a control unit. The exhaust unit has an exhaust port provided in the chamber and an exhaust blower capable of exhausting air through the exhaust port. The control unit controls the pressure inside the chamber by adjusting an air volume of the exhaust blower based on the pressure measured by the pressure measuring unit.

### Effects of the Invention

According to an embodiment, it is possible to solve or suppress the problems related to the movement of gas inside the heat treatment unit of the stretching apparatus or the movement of gas between the inside and outside of the heat treatment unit.

### BRIEF DESCRIPTIONS OF THE DRAWINGS

FIG. 1 is a schematic diagram showing a configuration of a thin-film manufacturing system according to an embodiment.

FIG. 2 is a plan view showing a configuration of the stretching apparatus shown in FIG. 1.

FIG. 3 is a transparent plan view of the stretching apparatus shown in FIG. 2.

FIG. 4 is an explanatory diagram of the stretching apparatus.

FIG. 5 is a cross-sectional view of a heat treatment unit of the stretching apparatus.

FIG. 6 is a cross-sectional view of the heat treatment unit of the stretching apparatus.

FIG. 7 is a cross-sectional view of the heat treatment unit of the stretching apparatus.

FIG. 8 is a graph showing an example of pressure distribution in the chamber of the heat treatment unit of the stretching apparatus.

FIG. 9 is a graph showing an example of pressure distribution in the chamber of the heat treatment unit of the stretching apparatus.

FIG. 10 is a graph showing an example of pressure distribution in the chamber of the heat treatment unit of the stretching apparatus.

FIG. 11 is a graph showing an example of pressure distribution in the chamber of the heat treatment unit of the stretching apparatus.

FIG. 12 is a graph showing an example of pressure distribution in the chamber of the heat treatment unit of the stretching apparatus.

FIG. 13 is a graph showing an example of pressure distribution in the chamber of the heat treatment unit of the stretching apparatus.

FIG. 14 is an explanatory diagram of the heat treatment unit of the stretching apparatus.

FIG. 15 is a flow diagram showing pressure control.

FIG. 16 is a graph showing a measured pressure and an output of an inverter.

FIG. 17 is an explanatory diagram showing an operation unit configured to operate switching of control for a plurality of zones of the chamber.

FIG. 18 is an explanatory diagram of the heat treatment unit of the stretching apparatus.

FIG. 19 is an explanatory diagram of the heat treatment unit of the stretching apparatus.

FIG. 20 is a flow diagram showing pressure control.

FIG. 21 is a cross-sectional view of the heat treatment unit of the stretching apparatus.

FIG. 22 is a cross-sectional view of the heat treatment unit of the stretching apparatus.

### DETAILED DESCRIPTION OF PREFERRED EMBODIMENTS

Hereinafter, embodiments will be described in detail based on drawings. Note that members having the same function are denoted by the same reference characters in all of the drawings for describing the embodiments, and the repetitive description thereof will be omitted. Also, in the following embodiments, the description of the same or similar parts will not be repeated in principle unless particularly required.

### First Embodiment

### <Overall Configuration of Manufacturing System>

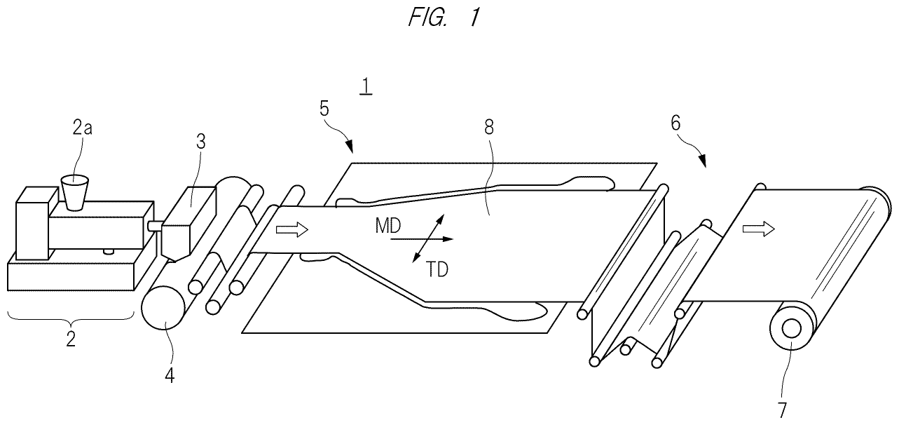

FIG. 1 is a schematic diagram showing a configuration of a thin-film manufacturing system according to the present embodiment.

A thin-film manufacturing system 1 according to the present embodiment shown in FIG. 1 includes an extrusion apparatus 2, a T-die (mold) 3 attached to the extrusion apparatus 2, a raw sheet cooling apparatus 4, a stretching apparatus 5, a take-off apparatus 6, and a winder apparatus 7.

Next, an outline of the operation of the thin-film manufacturing system 1 will be described.

First, a raw material is supplied into the extrusion apparatus 2 from a raw material supply unit 2a of the extrusion apparatus 2. The raw material supplied to the extrusion apparatus 2 is made of a resin material, additives, and the like. As the resin material, a thermoplastic resin material is preferably used. The extrusion apparatus 2 transports (conveys) the raw material supplied to the extrusion apparatus 2 while kneading (mixing) it. For example, the raw material supplied into the extrusion apparatus 2 is melted and kneaded while being sent forward by the rotation of a screw in the extrusion apparatus 2. The kneaded material (molten resin) kneaded in the extrusion apparatus 2 is supplied to the T-die 3, passes through the inside of the T-die 3, and is extruded from a slit of the T-die 3 to the raw sheet cooling apparatus 4. The kneaded material (molten resin) supplied from the extrusion apparatus 2 to the T-die 3 is molded into a predetermined cross-sectional shape (here, a film shape) by passing through the T-die 3.

The kneaded material (molten resin) extruded from the T-die 3 is cooled into a film (sheet, resin film) 8 in the raw sheet cooling apparatus 4. The film 8 is a film in a solidified state (solid state). More particularly, the film 8 is a thermoplastic resin film. The film 8 is fed to the stretching apparatus 5. Since the molded kneaded material (molten resin) is continuously extruded from the T-die 3, the film 8 is continuously supplied to the stretching apparatus 5. In the following, a case where a transverse stretching apparatus configured to perform a stretching process in the transverse direction (TD direction) to the film 8 is used as the stretching apparatus 5 will be described as an example.

The film 8 supplied (conveyed) from the raw sheet cooling apparatus 4 to the stretching apparatus 5 is stretched in the TD direction by the stretching apparatus 5. In addition, a longitudinal stretching apparatus (not shown) configured to perform a stretching process in the longitudinal direction (MD direction) to the film 8 can be arranged between the raw sheet cooling apparatus 4 and the stretching apparatus 5. In that case, the stretching process in the MD direction is performed to the film 8 by the longitudinal stretching apparatus, and the stretching process in the TD direction is performed to the film 8 by the stretching apparatus 5.

The film 8 that has been subjected to the stretching process (extending process) in the stretching apparatus 5 is conveyed to the winder apparatus 7 via the take-off apparatus 6 and wound up by the winder apparatus 7. The film 8 wound on the winder apparatus 7 is cut by a cutter (not shown) as necessary.

In this manner, a thin film can be manufactured using the thin-film manufacturing system 1. Note that the thin-film manufacturing system 1 shown in FIG. 1 is just an example, and various modifications are possible depending on the properties of the thin film to be formed. For example, the case in which an extraction tank (not shown) is provided near the take-off apparatus 6 shown in FIG. 1 and the plasticizer (for example, paraffin) in the film 8 is removed in the extraction tank is also possible.

The stretching apparatus according to the present embodiment stretches the film 8 in the TD direction while conveying the film 8 in the MD direction. The MD (Machine Direction) direction is the conveying direction of the film, and is referred to also as the longitudinal direction. Further, the TD (Transverse Direction) direction is the direction intersecting the conveying direction of the film, and is referred to also as the transverse direction. The MD direction and the TD direction are directions that intersect each other, more specifically, directions that are orthogonal to each other.

### <Stretching Apparatus>

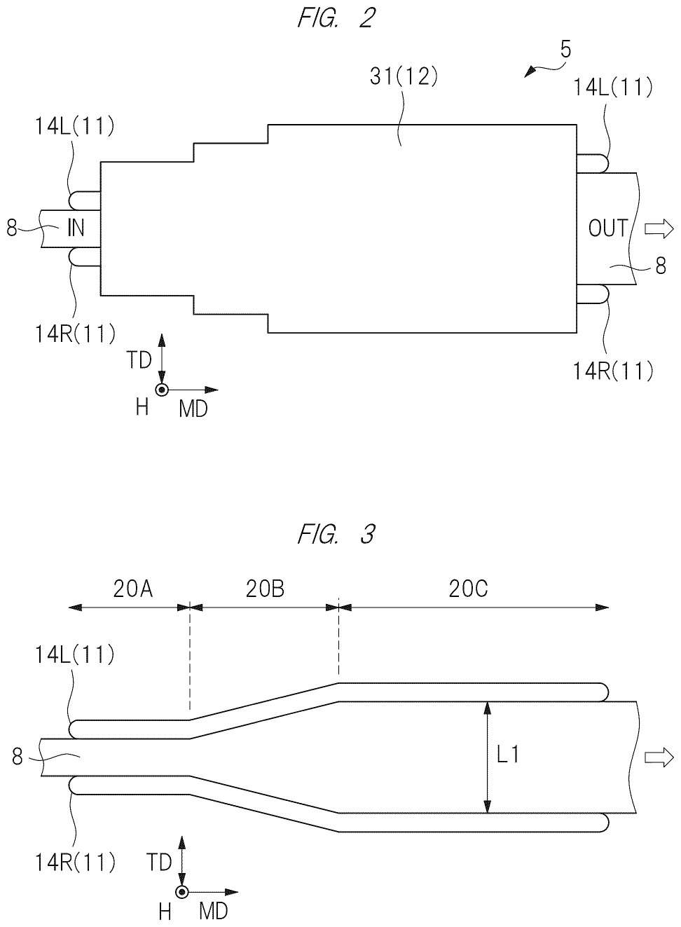

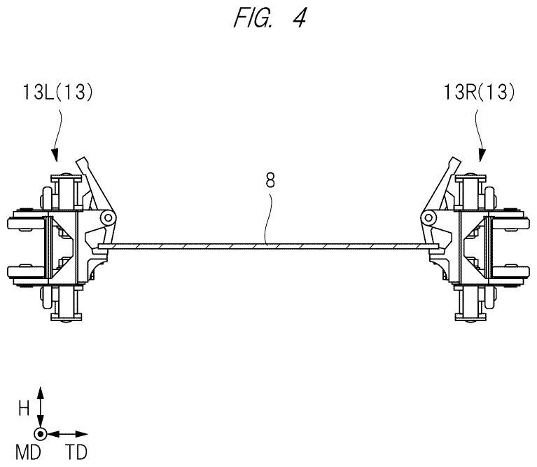

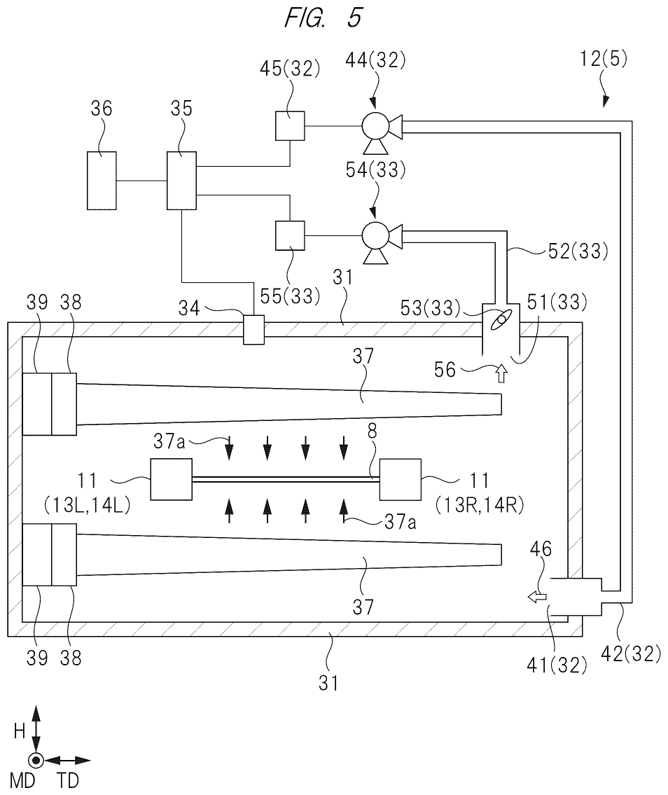

Next, the stretching apparatus 5 will be described. FIG. 2 is a plan view showing the configuration of the stretching apparatus 5 shown in FIG. 1. FIG. 3 is a transparent plan view of the stretching apparatus 5, and shows the case in which the stretching apparatus 5 is seen through a heat treatment unit 12 in FIG. 2. In FIG. 1 above, the heat treatment unit 12 is not shown for ease of understanding. Moreover, since FIG. 2 and FIG. 3 are schematic diagrams, the dimensional ratios of the respective members are different from those of the actual aspect. FIG. 4 is an explanatory diagram of the stretching apparatus 5, and shows the state in which both ends of the film 8 are held by clips 13L and 13R in the stretching apparatus 5.

As shown in FIG. 2 and FIG. 3, the stretching apparatus 5 includes a conveying device 11 for conveying the film 8 and the heat treatment unit (heat treatment device) 12 for performing the heat treatment to the film 8.

The conveying device 11 has a pair of guide rails 14L and 14R configured to guide the movement of the clips 13 and a plurality of clips 13 configured to hold the film 8 and move along the guide rails 14L and 14R. Here, the clips 13 moving along the guide rail 14L are denoted by a reference character 13L and referred to as clips 13L, and the clips 13 moving along the guide rail 14R are denoted by a reference character 13R and referred to as clips 13R. The conveying device 11 has a function of conveying the film 8 and a function of performing the stretching process to the film 8.

In the case of FIG. 2 and FIG. 3, the guide rail 14R is arranged on the right side with respect to the conveying direction (MD direction), and the guide rail 14L is arranged on the left side with respect to the conveying direction (MD direction). The guide rail 14R and the guide rail 14L are spaced apart in the TD direction and face each other in the TD direction with the film 8 interposed therebetween. The guide rails 14L and 14R are each arranged in an annular shape.

In the conveying device 11, the plurality of clips 13L are arranged so as to be movable along the guide rail 14L, and the plurality of clips 13R are arranged so as to be movable along the guide rail 14R. The film 8 is disposed between the guide rail 14R and the guide rail 14L, and one end (left end) thereof in the TD direction is held by the clip 13L and the other end (right end) thereof in the TD direction is held by the clip 13R. As the clips 13L and 13R move along the guide rails 14L and 14R, the film 8 held by the clips 13L and 13R is conveyed in the MD direction between the guide rail 14R and the guide rail 14L.

The stretching apparatus 5 has three regions 20A, 20B, and 20C in plan view. The region 20A is a preheating region (preheat region), the region 20B is a stretching region, and the region 20C is a heat setting region. In the MD direction, the region 20A, the region 20B, and the region 20C are arranged in this order, and the region 20B is located between the region 20A and the region 20C. An inlet of the film 8 in the stretching apparatus 5 (corresponding to the part indicated as “IN” in FIG. 2) is located in the region 20A, and an outlet of the film 8 in the stretching apparatus 5 (corresponding to the part indicated as “OUT” in FIG. 2) is located in the region 20C. The direction from the inlet to the outlet of the film 8 in the stretching apparatus 5 corresponds to the conveying direction (MD direction) of the film 8.

The heat treatment unit 12 covers the conveying device 11 except for a part on the inlet side and a part on the outlet side. Therefore, the conveying device 11 is arranged inside a chamber 31 of the heat treatment unit 12 except for a part on the inlet side and a part on the outlet side. FIG. 2 shows a case in which an oven is used as the heat treatment unit 12. The film 8 passes through the chamber 31 of the heat treatment unit 12 while being held by the clips 13L and 13R of the conveying device 11. While the film 8 passes through the chamber 31 of the heat treatment unit 12, the film 8 can be heated in the chamber 31 to a desired temperature. Therefore, the stretching process to the film 8 can be performed at a temperature suitable for the stretching process.

Next, the operation of the stretching apparatus 5 will be described.

The film 8 supplied (conveyed) from the raw sheet cooling apparatus 4 to the stretching apparatus 5 is held by the clips 13L and 13R provided on the conveying device 11 at the inlet of the stretching apparatus 5. Namely, one end of the film 8 is held by the clip 13L of the conveying device 11, and the other end of the film 8 is held by the clip 13R of the conveying device 11. Also, since the film 8 held by the clips 13L and 13R is conveyed together with the clips 13L and 13R in the MD direction from the inlet to the outlet of the stretching apparatus 5, it passes through the region 20A, the region 20B, and the region 20C in this order. The film 8 held by the clips 13L and 13R is heated while passing through the region 20A, the region 20B, and the region 20C, and is stretched in the TD direction when passing through the region 20B. Then, the film 8 held by the clips 13L and 13R reaches the outlet of the stretching apparatus 5, where it is released from the clips 13L and 13R. The film 8 released from the clips 13L and 13R is conveyed from the outlet of the stretching apparatus 5 to the take-off apparatus 6, and then conveyed from the take-off apparatus 6 to the winder apparatus 7 to be wound up.

The operation of the stretching apparatus 5 in the region 20B will be further described.

In the region 20B, a distance (distance in the TD direction) L1 between the guide rail 14L and the guide rail 14R gradually increases as advancing in the MD direction. The clip 13L moves along the guide rail 14L, and the clip 13R moves along the guide rail 14R. Therefore, in the region 20B, a distance (distance in the TD direction) between the clip 13L holding one end of the film 8 and the clip 13R holding the other end of the film 8 gradually increases as advancing in the MD direction. Therefore, in the region 20B, the film 8 is pulled and extended in the TD direction by the clip 13L and the clip 13R as the film 8 advances in the MD direction, so that the film 8 is stretched in the TD direction. In this way, the stretching process in the TD direction is performed to the film 8 in the region 20B.

The operation of the stretching apparatus 5 in the region 20A and the region 20C will be further described.

In the region 20A, the distance L1 between the guide rail 14L and the guide rail 14R is almost constant. In the region 20C as well, the distance L1 between the guide rail 14L and the guide rail 14R is almost constant. Therefore, the stretching process to the film 8 is not performed in the region 20A and the region 20C.

### <Air Supply and Exhaust of Stretching Apparatus>

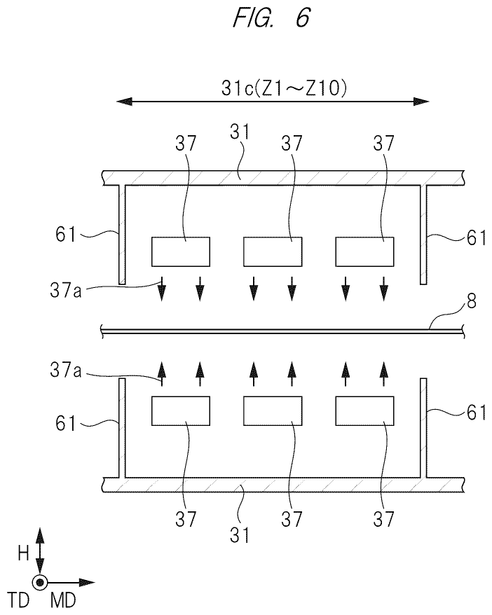

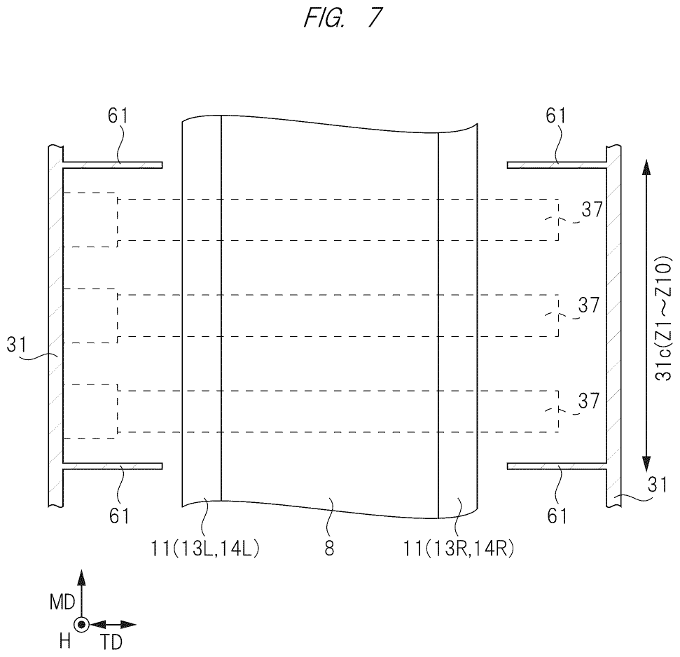

FIG. 5 to FIG. 7 are cross-sectional views of the heat treatment unit 12 of the stretching apparatus 5. FIG. 5 corresponds to a cross-sectional view that is approximately parallel to the TD direction and approximately perpendicular to the MD direction, FIG. 6 corresponds to a cross-sectional view that is approximately parallel to the MD direction and approximately perpendicular to the TD direction, and FIG. 7 corresponds to a cross-sectional view that is approximately parallel to both the TD direction and the MD direction. In addition, although the TD direction, the MD direction, and an H direction are indicated in FIG. 5 to FIG. 7, the H direction is the height direction. The H direction is approximately perpendicular to both the TD direction and the MD direction.

The heat treatment unit 12 of the stretching apparatus 5 according to the present embodiment has an air supply and exhaust mechanism. Specifically, the heat treatment unit 12 has a chamber (oven chamber) 31, an air supply unit (air supply system, air supply mechanism) 32 configured to supply air into the chamber 31, an exhaust unit (exhaust system, exhaust mechanism) 33 configured to exhaust air from the chamber 31, a pressure measuring unit (pressure gauge) 34, and a control unit 35 configured to control them. Also, the stretching apparatus 5 further includes an operation unit (operation panel) 36 configured to perform various operations and displays related to the stretching apparatus 5. The operation unit 36 has various buttons, an input keyboard, and the like. Further, a display unit provided in the operation unit 36 can display a set pressure SV and a measured pressure PV to be described later. The control unit 35 includes, for example, a semiconductor device for control (processor) and a semiconductor device for storage (memory). The control unit 35 can perform various types of control based on information input to the operation unit 36, information stored in the control unit 35, and the like.

As described above, the conveying device 11 is arranged in the chamber 31 of the heat treatment unit 12 except for a part near the inlet of the film 8 and a part near the outlet of the film 8. Therefore, the film 8 held by the clips 13L and 13R of the conveying device 11 passes through the chamber 31 of the heat treatment unit 12, during which the stretching process and the heat treatment are performed in the chamber 31. The chamber 31 has an inlet 31a through which the film 8 is conveyed into the chamber 31 and an outlet 31b through which the film 8 is conveyed out of the chamber 31.

In the heat treatment unit 12, air can be supplied into the chamber 31 via the air supply unit 32, and the air in the chamber 31 can be exhausted to the outside of the chamber 31 via the exhaust unit 33.

The air supply unit 32 has an air supply port (opening) 41 for supplying air into the chamber 31, an air supply pipe (air supply duct, air supply path) 42 connected to the air supply port 41, a blower (air blower) 44 connected to the air supply pipe 42, and an inverter 45 connected to the blower 44. The blower 44 can function as an air blower for supplying air. The air supply pipe 42 is connected to an air blowing side of the blower 44. The air supply port 41 can be provided in a ceiling portion, a bottom portion, or a side wall portion of the chamber 31. An output of the inverter 45 connected to the blower 44 is input to a motor constituting the air supply blower 44. Therefore, the rotation speed of the motor constituting the air supply blower 44 can be controlled by the output of the inverter 45 connected to the blower 44.

The exhaust unit 33 has an exhaust port (opening) 51 for exhausting air from the chamber 31, an exhaust pipe (exhaust duct, exhaust path) 52 connected to the exhaust port 51, a damper 53 provided in the exhaust pipe 52, a blower (air blower) 54 connected to the exhaust pipe 52, and an inverter 55 connected to the blower 54. The blower 54 can function as an air blower for exhausting air. The exhaust pipe 52 is connected to a suction side of the blower 54. The exhaust port 51 can be provided in the ceiling portion, the bottom portion, or the side wall portion of the chamber 31. An output of the inverter 55 connected to the blower 54 is input to a motor constituting the exhaust blower 54. Therefore, the rotation speed of the motor constituting the exhaust blower 54 can be controlled by the output of the inverter 55 connected to the blower 54. In addition, in the case of FIG. 5 to FIG. 7, the damper 53 is provided in the exhaust pipe 52, whereas no damper is provided in the air supply pipe 42. However, in other embodiments, a damper may also be provided in the air supply pipe 42.

The heat treatment unit 12 further includes nozzles 37, heaters (heating units, heating mechanisms) 38, and blower fans 39. The nozzles 37 are arranged above and below the film 8, respectively, and the air heated by the heaters 38 is sent to the nozzles 37 by the blower fans 39 and is blown toward the film 8 through a plurality of holes provided in the nozzles 37.

The air is supplied into the chamber 31 by the air supply unit 32. Specifically, the air sent to the air supply pipe 42 by the blower 44 passes through the air supply pipe 42 and is supplied into the chamber 31 from the air supply port 41. In FIG. 5, the air supplied from the air supply port 41 into the chamber 31 is schematically illustrated by an arrow denoted by the reference character 46. The air in the chamber 31 moves (circulates) inside the chamber 31 in accordance with the air flow generated by the blower fans 39, is heated by the heaters 38, is sent to the nozzles 37, and is blown toward the film 8 through the plurality of holes provided in the nozzles 37. In FIG. 5 and FIG. 6, the heated air blown from the nozzles 37 to the film 8 is illustrated by arrows denoted by the reference character 37a. The film 8 can be heated by blowing heated air (hot wind) onto the film 8. In this way, the heat treatment can be performed to the film 8 in the chamber 31. Therefore, it is desirable to adjust the heaters 38 such that the temperature of the air heated by the heaters 38 becomes a temperature suitable for heating the film 8. The heated air blown toward the film 8 from the plurality of holes in the nozzles 37 circulates inside the chamber 31 in accordance with the air flow generated by the blower fans 39, is heated again by the heaters 38, and is blown toward the film 8 through the plurality of holes in the nozzles 37.

A part of the air inside the chamber 31 is exhausted to the outside of the chamber 31 from the exhaust unit 33. Specifically, the blower 54 sucks in the air in the exhaust pipe 52, whereby the air in the chamber 31 is sucked in through the exhaust pipe 52 and the exhaust port 51, and the air inside the chamber 31 is exhausted from the exhaust port 51 to the outside of the chamber 31 through the exhaust pipe 52. In FIG. 5, the air exhausted from the exhaust port 51 is schematically illustrated by an arrow denoted by the reference character 56. The damper 53 is an exhaust damper and has a function of adjusting the air volume passing through the exhaust pipe 52. Note that the air volume corresponds to the amount (volume) of air moving (passing) per unit time.

The control unit 35 can control the air volume of each of the blowers 44 and 54 by adjusting the output of each of the inverters 45 and 55. The air volume of the blower 44 can be controlled by adjusting the output of the inverter 45, whereby the air volume supplied into the chamber 31 from the air supply port 41 through the air supply pipe 42 (amount of air supplied per unit time) can be controlled. Specifically, when the output from the inverter 45 to the blower 44 is increased, the rotation speed of the motor of the blower 44 increases and the air volume of the blower 44 increases, whereby the air volume supplied into the chamber 31 from the air supply port 41 through the air supply pipe 42 is increased. On the other hand, when the output from the inverter 45 to the blower 44 is reduced, the rotation speed of the motor of the blower 44 decreases and the air volume of the blower 44 decreases, whereby the air volume supplied into the chamber 31 from the air supply port 41 through the air supply pipe 42 is reduced.

In addition, the air volume of the blower 54 can be controlled by adjusting the output of the inverter 55, whereby the air volume exhausted from the chamber 31 through the exhaust port 51 and the exhaust pipe 52 (amount of air exhausted per unit time) can be controlled. Specifically, when the output from the inverter 55 to the blower 54 is increased, the rotation speed of the motor of the blower 54 increases and the air volume of the blower 54 increases, whereby the air volume exhausted from the chamber 31 through the exhaust port 51 and the exhaust pipe 52 is increased. On the other hand, when the output from the inverter 55 to the blower 54 is reduced, the rotation speed of the motor of the blower 54 decreases and the air volume of the blower 54 decreases, whereby the air volume exhausted from the chamber 31 through the exhaust port 51 and the exhaust pipe 52 is reduced.

In addition, the control unit 35 can also control the opening/closing degree of the damper 53. By controlling the opening/closing degree of the damper 53, the air volume exhausted from the chamber 31 through the exhaust pipe 52 in which the damper 53 is provided can be controlled. Specifically, the air volume exhausted from the chamber 31 through the exhaust pipe 52 in which the damper 53 is provided increases when the damper 53 is brought closer to an open state, whereas the air volume exhausted from the chamber 31 through the exhaust pipe 52 in which the damper 53 is provided decreases when the damper 53 is brought closer to a closed state.

The pressure measuring unit 34 capable of measuring the pressure inside the chamber 31 is provided in the chamber 31. The pressure measuring unit 34 is specifically a pressure gauge or a pressure measuring device, and for example, a manometer (differential pressure gauge) can be used. When a manometer is used as the pressure measuring unit 34, the difference (differential pressure) between the pressure inside the chamber 31 and the pressure outside the chamber 31 can be measured by the pressure measuring unit 34.

The pressure inside the chamber 31 of the heat treatment unit 12 of the stretching apparatus 5 can be controlled by adjusting the air supply amount of the air supply unit 32, specifically, the air volume supplied from the air supply port 41 into the chamber 31 through air supply pipe 42 and the exhaust amount of the exhaust unit 33, specifically, the air volume exhausted from the chamber 31 through the exhaust port 51 and the exhaust pipe 52. Note that the pressure inside the chamber 31 may be referred to as the internal pressure below. Moreover, the pressure outside the chamber 31 may be referred to as the external pressure below. The pressure outside the chamber 31, that is, the external pressure is approximately equal to the atmospheric pressure.

### <Pressure Inside Chamber of Heat Treatment Unit of Stretching Apparatus>

In the present embodiment, the pressure measuring unit 34 can measure the pressure inside the chamber 31, and the control unit 35 can control the pressure inside the chamber 31 by adjusting the air volume of the exhaust blower 54 based on the pressure measured by the pressure measuring unit 34. Specifically, the control unit 35 can control the pressure inside the chamber 31 by adjusting the output from the inverter 55 to the exhaust blower 54 based on the pressure measured by the pressure measuring unit 34 to adjust the air volume of the exhaust blower 54. When the output from the inverter 55 to the blower 54 is increased, the air volume of the exhaust blower 54 increases, and the pressure inside the chamber 31 decreases. Further, when the output from the inverter 55 to the blower 54 is reduced, the air volume of the exhaust blower 54 decreases, and the pressure inside the chamber 31 increases. Therefore, when the control unit 35 determines that the pressure measured by the pressure measuring unit 34 is outside the allowable range, it adjusts the output from the inverter 55 to the exhaust blower 54 such that the pressure inside the chamber 31 is within the allowable range, whereby the pressure inside the chamber 31 can be controlled to the desired pressure.

Problems related to the movement of gas inside the heat treatment unit of the stretching apparatus or the movement of gas between the inside and outside of the heat treatment unit include the generation of accompanying flow as the film to be stretched advances, the inflow of cold outside air into the heat treatment unit of the stretching apparatus through the inlet or outlet thereof, and the outflow of volatile components from the heat treatment unit of the stretching apparatus through the inlet or outlet thereof, and these problems may occur due to the pressure distribution in the chamber 31. In the present embodiment, since the pressure inside the chamber 31 can be controlled by adjusting the air volume of the exhaust blower 54 based on the pressure measured by the pressure measuring unit 34, the pressure inside the chamber 31 can be quickly and accurately controlled to the desired pressure. Therefore, the problems related to the movement of gas inside the heat treatment unit of the stretching apparatus or the movement of gas between the inside and outside of the heat treatment unit can be solved or suppressed.

The air volume of the blower 54 can also be adjusted by adjusting the opening/closing degree of the damper 53. Therefore, as another embodiment, the control unit 35 can also control the pressure inside the chamber 31 by adjusting the opening/closing degree of the damper 53 based on the pressure measured by the pressure measuring unit 34 to adjust the air volume of the exhaust blower 54. The air volume of the exhaust blower 54 increases and the pressure inside the chamber 31 decreases when the opening degree of the damper 53 is increased, and the air volume of the exhaust blower 54 decreases and the pressure inside the chamber 31 increases when the opening degree of the damper 53 is decreased. As still another embodiment, it is also possible to adjust both the output of the inverter 55 and the opening/closing degree of the damper 53 based on the pressure measured by the pressure measuring unit 34.

However, the device configuration required for automatic adjustment is simpler and fine adjustment of the air volume of the blower 54 is easier when the output of the inverter 55 is automatically adjusted by the control unit 35 than when the opening/closing degree of the damper 53 is automatically adjusted by the control unit 35. Therefore, it is more preferable to adjust the output from the inverter 55 to the exhaust blower 54 based on the pressure measured by the pressure measuring unit 34.

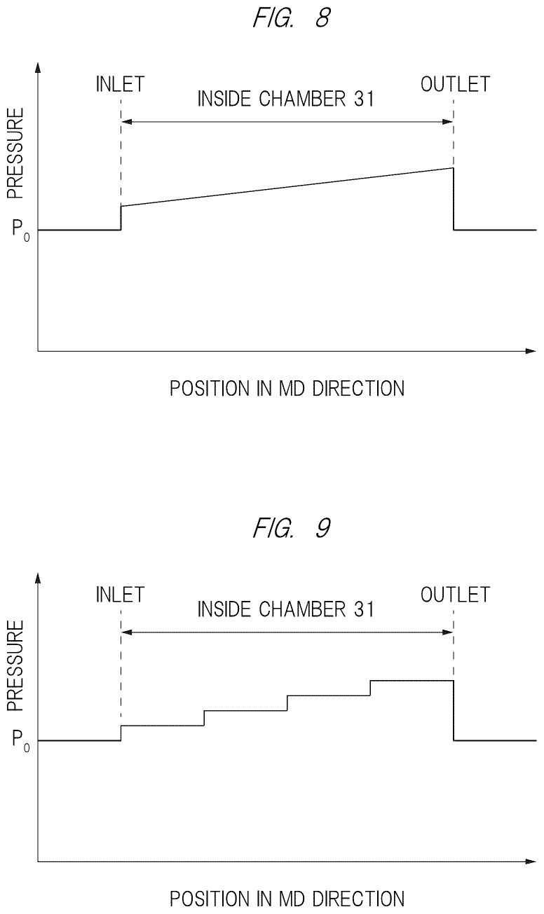

Next, an example of pressure distribution in the chamber 31 of the heat treatment unit 12 of the stretching apparatus 5 will be described. FIG. 8 to FIG. 13 are graphs showing examples of pressure distribution in the chamber 31 of the heat treatment unit 12 of the stretching apparatus 5. The horizontal axis of the graphs in FIG. 8 to FIG. 13 corresponds to the position in the MD direction, and the vertical axis of the graphs in FIG. 8 to FIG. 13 corresponds to the pressure. In the graphs of FIG. 8 to FIG. 13, the range indicated “inside chamber 31” corresponds to the pressure inside the chamber 31, and the range outside it corresponds to the pressure outside the chamber 31. The position indicated as “inlet” in the graphs of FIG. 8 to FIG. 13 corresponds to the inlet 31a of the chamber 31, and the position indicated as “outlet” in the graphs of FIG. 8 to FIG. 13 corresponds to the outlet 31b of the chamber 31. The pressure outside the chamber 31 is approximately equal to the atmospheric pressure P₀.

In the case of the pressure distribution in FIG. 8 and the pressure distribution in FIG. 9, the pressure inside the chamber 31 is higher than the pressure outside the chamber 31. Also, the pressure inside the chamber 31 increases as advancing from the inlet side to the outlet side in the MD direction. In this case, the internal pressure of each of the above-mentioned regions 20A, 20B, and 20C is higher than the external pressure, the internal pressure of the region 20B is higher than that of the region 20A, and the internal pressure of the region 20C is higher than that of the region 20B.

In the pressure distribution in FIG. 8, the pressure inside the chamber 31 gradually increases as advancing in the MD direction. On the other hand, in the pressure distribution in FIG. 9, the pressure inside the chamber 31 increases stepwise as advancing in the MD direction.

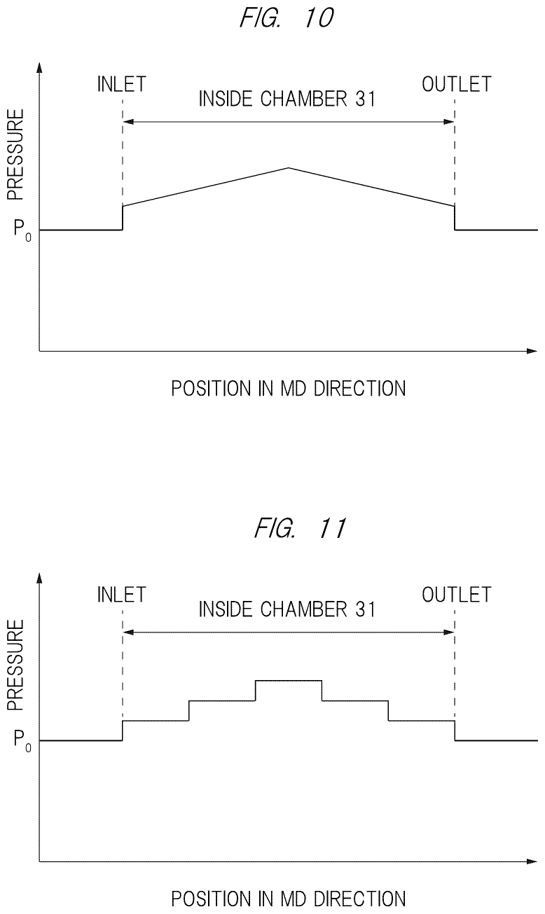

In the case of the pressure distribution in FIG. 10 and the pressure distribution in FIG. 11, the pressure inside the chamber 31 is higher than the pressure outside the chamber 31. Also, the pressure inside the chamber 31 is higher at the center in the MD direction than those on the inlet and outlet sides. In this case, the internal pressure of each of the above-mentioned regions 20A, 20B, and 20C is higher than the external pressure, the internal pressure of the region 20B is higher than that of the region 20A, and the internal pressure of the region 20B is higher than that of the region 20C.

In the pressure distribution in FIG. 10, the pressure inside the chamber 31 gradually increases as advancing from the inlet and outlet sides toward the center in the MD direction. In the pressure distribution in FIG. 11, the pressure inside the chamber 31 increases stepwise as advancing from the inlet and outlet sides toward the center in the MD direction.

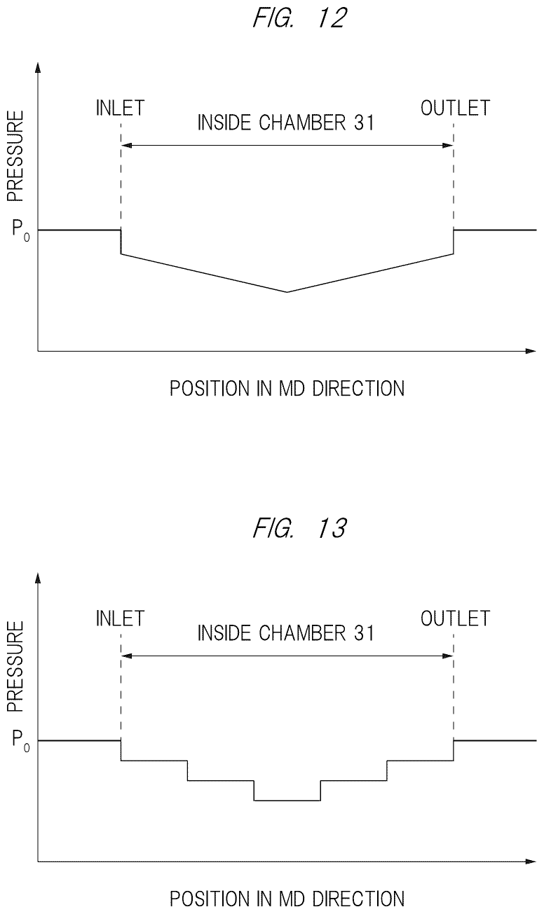

In the case of the pressure distribution in FIG. 12 and the pressure distribution in FIG. 13, the pressure inside the chamber 31 is lower than the pressure outside the chamber 31. Also, the pressure inside the chamber 31 is lower at the center in the MD direction than those on the inlet and outlet sides. In this case, the internal pressure of each of the above-mentioned regions 20A, 20B, and 20C is lower than the external pressure, the internal pressure of the region 20B is lower than that of the region 20A, and the internal pressure of the region 20B is lower than that of the region 20C.

In the pressure distribution in FIG. 12, the pressure inside the chamber 31 gradually decreases as advancing from the inlet and outlet sides toward the center in the MD direction. On the other hands, in the pressure distribution in FIG. 13, the pressure inside the chamber 31 decreases stepwise as advancing from the inlet and outlet sides toward the center in the MD direction.

When the pressure distribution in the chamber 31 is controlled as shown in FIG. 8 and FIG. 9, the following advantages can be obtained. That is, it is possible to prevent or suppress the generation of the accompanying flow in the chamber 31. Here, the accompanying flow corresponds to the air flow along the advancing direction of the film 8 from the inlet side to the outlet side when the film 8 is conveyed in the chamber 31 in the MD direction from the inlet side to the outlet side by the conveying device 11. If the accompanying flow is generated in the chamber 31, the temperature is likely to fluctuate in the vicinity of the film 8, which may result in non-uniform properties of the film 8 after the stretching process. When the pressure distribution in the chamber 31 is controlled as shown in FIG. 8 and FIG. 9, since it is possible to prevent or suppress the generation of the accompanying flow in the chamber 31, it is possible to suppress or prevent the temperature in the vicinity of the film 8 from fluctuating due to the generation of the accompanying flow in the chamber 31, and the properties of the film 8 after the stretching process can be made uniform.

When the pressure distribution in the chamber 31 is controlled as shown in FIG. 10 and FIG. 11, the following advantages can be obtained. That is, it is possible to suppress or prevent cold outside air from flowing into the chamber 31 on both the inlet side and the outlet side. This makes it easier to control the temperature inside the chamber 31, and makes it easier to perform the stretching process while performing the heat treatment to the film 8 in the chamber 31. As a result, the properties of the film 8 after the stretching process can be made uniform.

When the pressure distribution in the chamber 31 is controlled as shown in FIG. 12 and FIG. 13, the following advantages can be obtained. That is, it is possible to more reliably prevent the air inside the chamber 31 from leaking out of the chamber 31 on both the inlet side and the outlet side. This makes it possible to more reliably prevent substances (such as volatile gas components) generated in the chamber 31 from leaking out of the chamber 31.

A target value for the pressure distribution in the chamber 31 can be set depending on the type and components of the film 8 to which the stretching process is performed, and the stretching process of the film 8 can be performed while controlling the pressure distribution in the chamber 31 to the target value. In this way, since it is possible to perform the stretching process of the film 8 while controlling the pressure distribution in the chamber 31 to a pressure distribution suitable for the film 8 to be stretched, it is possible to accurately perform the stretching process of the film 8 by using the stretching apparatus 5.

### First Example of Method of Controlling Pressure Inside Chamber

An example of a method of controlling the pressure inside the chamber 31 will be described below.

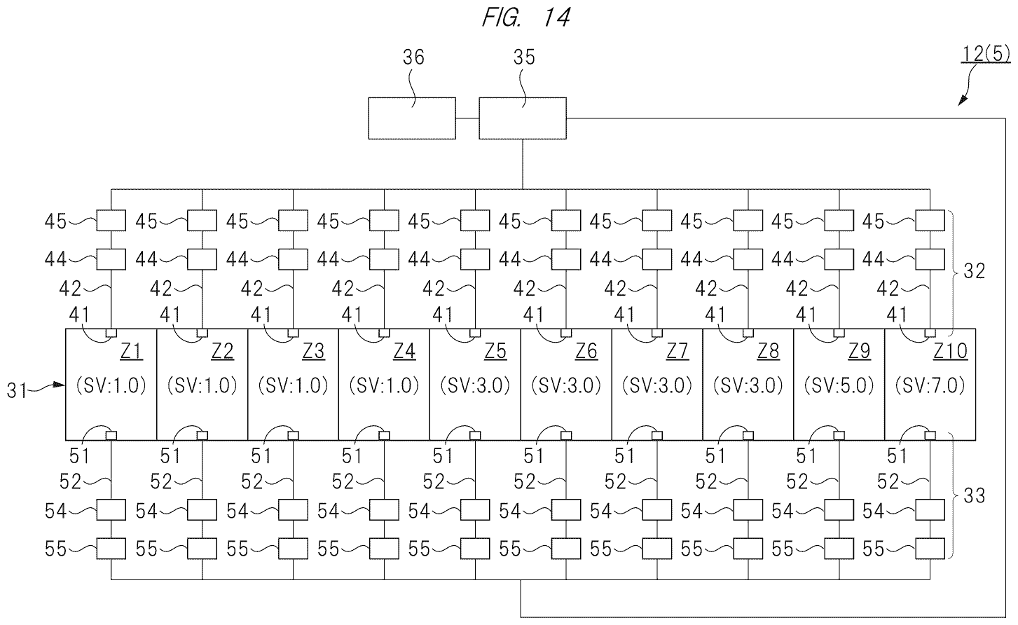

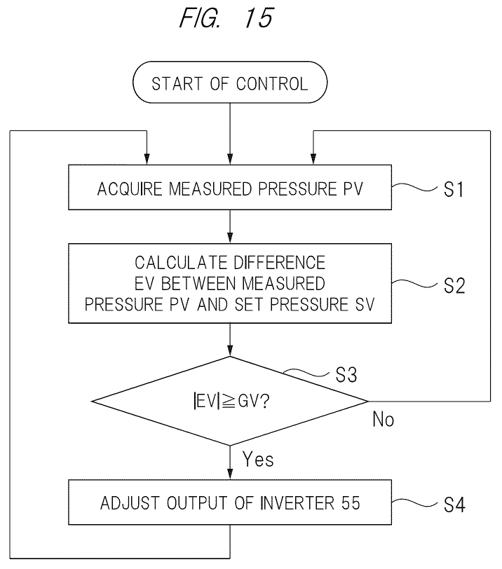

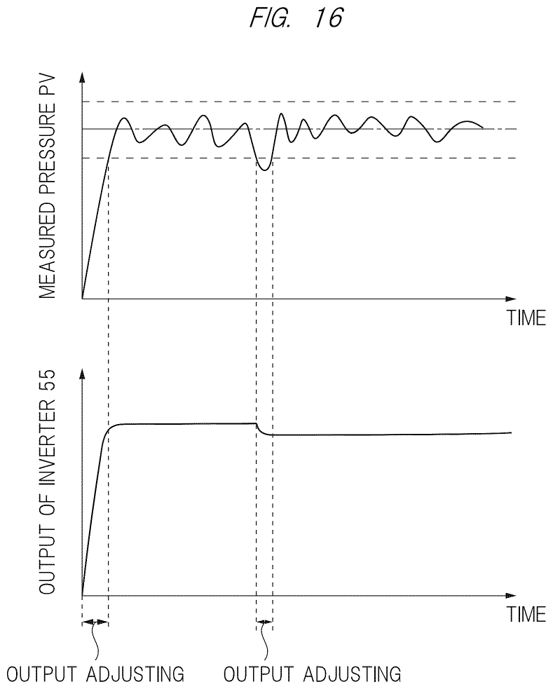

First, a first example of a method of controlling the pressure inside the chamber 31 will be described with reference to FIG. 14 and FIG. 15. FIG. 14 is an explanatory diagram showing the heat treatment unit 12 of the stretching apparatus 5. FIG. 15 is a flow diagram showing pressure control.

The chamber 31 has a plurality of zones (rooms, sections) Z1 to Z10, and the plurality of zones Z1 to Z10 are arranged in order in the MD direction from the inlet side to the outlet side. The conveying device 11 and the film 8 held thereby are arranged across the plurality of zones Z1 to Z10. The plurality of zones Z1 to Z10 may be virtual zones, but are preferably separated by partition walls (partition plates) 61. The partition walls 61 are connected to the inner wall of the chamber 31. The partition walls 61 are shown in FIG. 6 and FIG. 7 above. The range denoted by the reference character 31c shown in FIG. 6 and FIG. 7 above corresponds to any one of the plurality of zones Z1 to Z10. Therefore, each of the zones Z1 to Z10 has the structure shown in FIG. 5 to FIG. 7 above, but the control unit 35 and the operation unit 36 are common to the plurality of zones Z1 to Z10. By arranging the partition walls 61 between the respective zones Z1 to Z10, it is possible to suppress the generation of air flow (movement) between the respective zones Z1 to Z10. In addition, the partition wall 61 is designed so as not to interfere with the arrangement of the conveying device 11 and the movement of the film 8. Namely, in the chamber 31, the conveying device 11 and the film 8 conveyed thereby pass through a region where the partition wall 61 does not exist.

As described above, the chamber 31 of the heat treatment unit 12 has the region 20A which is the preheating region, the region 20B which is the stretching region, and the region 20C which is the heat setting region. In the case of FIG. 14, the chamber 31 has ten zones Z1 to Z10, among which four zones Z1, Z2, Z3, and Z4 constitute the region 20A which is the preheating region, four zones Z5, 26, 27, and 28 constitute the region 20B which is the stretching region, and two zones Z9 and Z10 constitute the region 20C which is the heat setting region. However, this is merely an example, and the number of zones constituting the chamber 31 and the number of zones constituting each of the regions 20A, 20B, and 20C can be changed in various ways.

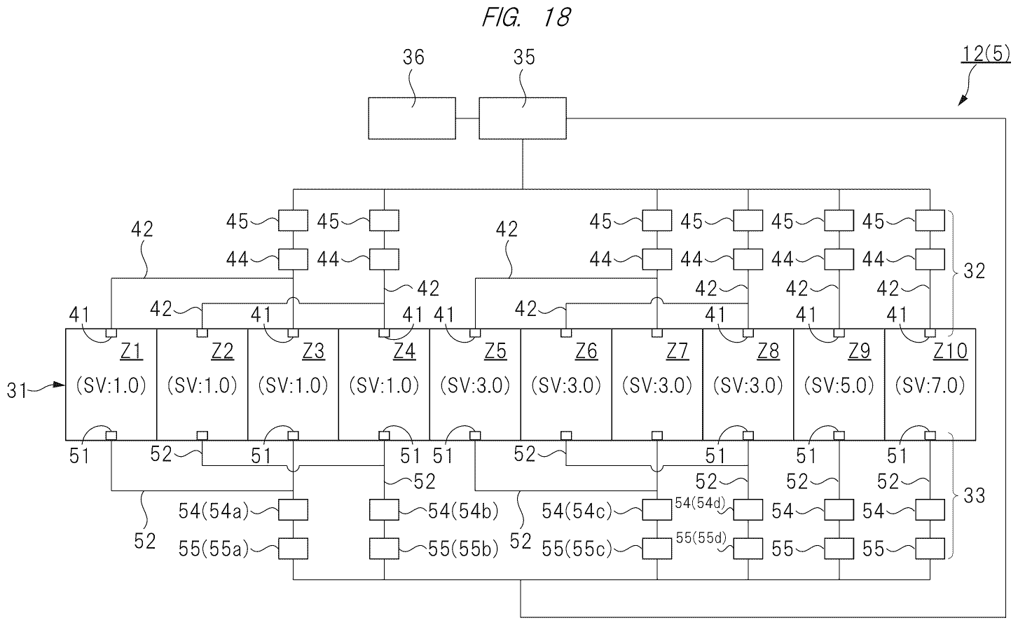

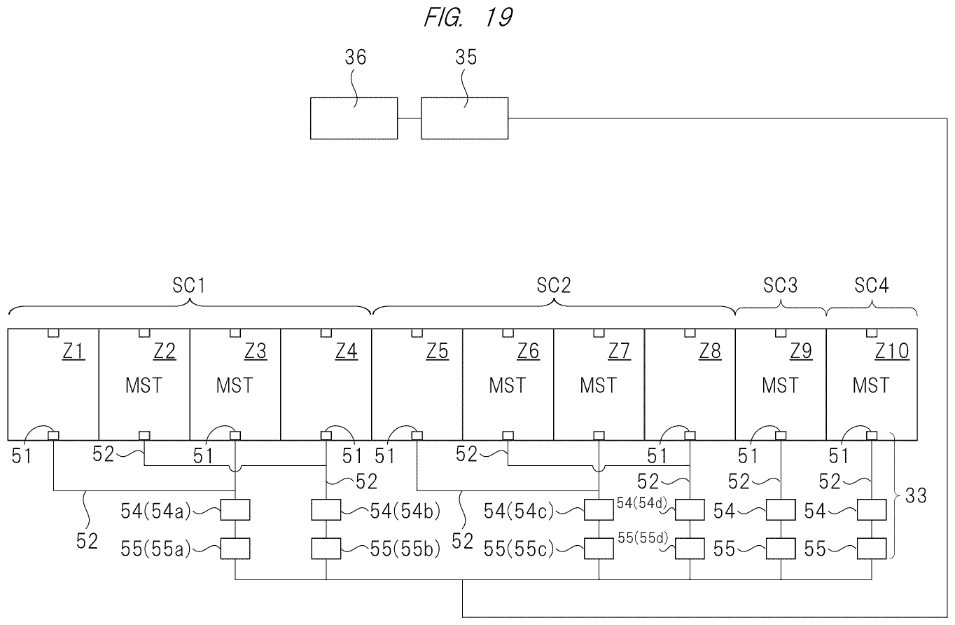

The above-mentioned pressure measuring unit 34, nozzle 37, heater 38, and blower fan 39 are provided for each of the plurality of zones Z1 to Z10 of the chamber 31. Therefore, each of the zones Z1 to Z10 of the chamber 31 has the above-mentioned pressure measuring unit 34, nozzle 37, heater 38, and blower fan 39, and this applies not only to the case of FIG. 14 but also to the cases of FIG. 18 and FIG. 19 described below. Accordingly, when the film 8 passes through each of the zones Z1 to Z10 of the chamber 31, heated air is blown onto the film 8 from the plurality of holes of the nozzle 37 provided in each of the zones Z1 to Z10, whereby the heat treatment can be performed to the film 8. In addition, the pressure (internal pressure) of each of the zones Z1 to Z10 can be measured by the pressure measuring unit 34 provided in each of the zones Z1 to Z10.

Also, in the case of FIG. 14, the above-mentioned air supply unit 32 and exhaust unit 33 are provided for each of the plurality of zones Z1 to Z10 of the chamber 31. Therefore, the air supply port 41, the air supply pipe 42, the blower 44, and the inverter 45 constituting the air supply unit 32 and the exhaust port 51, the exhaust pipe 52, the damper 53, the blower 54, and the inverter 55 constituting the exhaust unit 33 are provided for each of the zones Z1 to Z10 of the chamber 31. Therefore, in the case of FIG. 14, in each of the plurality of zones Z1 to Z10 of the chamber 31, air can be supplied by the air supply unit 32 provided in the zone, and the air supply amount can be controlled by adjusting the output of the inverter 45 constituting the air supply unit 32. Further, in the case of FIG. 14, in each of the plurality of zones Z1 to Z10 of the chamber 31, air can be exhausted by the exhaust unit 33 provided in the zone, and the exhaust amount can be controlled by adjusting the opening/closing degree of the damper 53 or the output of the inverter 54 constituting the exhaust unit 33. Accordingly, the air supply amount can be controlled independently for each of the plurality of zones Z1 to Z10 of the chamber 31, and the exhaust amount can be controlled independently for each of the plurality of zones Z1 to Z10 of the chamber 31.

FIG. 14 also shows examples of the set pressure SV of each of the zones Z1 to Z10 of the chamber 31. Note that a differential pressure can also be used as both the set pressure SV and the measured pressure PV described later. The differential pressure corresponds to the difference between the internal pressure (pressure inside the chamber 31) and the external pressure (pressure outside the chamber 31). The examples of the set pressure SV shown in FIG. 14 are differential pressures, and the unit thereof is Pa.

In the examples of the set pressure SV shown in FIG. 14, the set pressures SV of the zones Z1 to Z4 are equal to each other at 1.0 Pa. Also, the set pressures SV of the zones Z5 to 28 are higher than the set pressures SV of the zones Z1 to Z4 and are equal to each other at 3.0 Pa. Further, the set pressure SV of the zone Z9 is 5.0 Pa higher than the set pressures SV of the zones Z5 to Z8. In addition, the set pressure SV of the zone Z10 is 7.0 Pa higher than the set pressure SV of the zone Z9. These correspond to the pressure distribution in FIG. 9 above.

The set pressure SV is the target value of the pressure of each of the zones Z1 to Z10 of the chamber 31, and is preferably set in advance before the stretching process of the film 8 by the stretching apparatus 5 is performed. For example, it is possible to input the set pressure SV of each of the zones Z1 to Z10 by the operation unit 36. Also, the measured pressure PV is the measured value of the pressure measuring unit 34. Since the pressure measuring unit 34 is provided for each of the plurality of zones Z1 to Z10 of the chamber 31, the pressure (differential pressure) of each of the zones Z1 to Z10 can be measured by the pressure measuring unit 34 provided for the zone.

The pressure control in the zone Z3 as a representative example of the plurality of zones Z1 to Z10 will be described with reference to FIG. 15.

Note that the exhaust unit 33 provided for the zone Z3 will be referred to below as the “exhaust unit 33 of the zone Z3”, and the exhaust port 51, the exhaust pipe 52, the damper 53, the blower 54, and the inverter 55 constituting the “exhaust unit 33 of the zone Z3” will be referred to below as the “exhaust port 51 of the zone Z3”, the “exhaust pipe 52 of the zone Z3”, the “damper 53 of the zone Z3”, the “blower 54 of the zone Z3”, and the “inverter 55 of the zone Z3”, respectively. In addition, the air supply unit 32 provided for the zone Z3 will be referred to below as the “air supply unit 32 of the zone Z3”, and the air supply port 41, the air supply pipe 42, the blower 44, and the inverter 45 constituting the “air supply unit 32 of the zone Z3” will be referred to below as the “air supply port 41 of the zone Z3”, the “air supply pipe 42 of the zone Z3”, the “blower 44 of the zone Z3”, and the “inverter 45 of the zone Z3”, respectively.

First, the pressure in the zone Z3 is measured by the pressure measuring unit 34 provided in the zone Z3, and the control unit 35 acquires the measured pressure PV (step S1 in FIG. 15).

Next, the control unit 35 calculates the difference EV between the measured pressure PV of the zone Z3 acquired in step S1 and the set pressure SV of the zone Z3 (step S2 in FIG. 15). Here, EV=PV−SV holds.

Next, the control unit 35 compares the absolute value of the difference EV calculated in step S2 with a predetermined allowable limit value GV (step S3 in FIG. 15). The allowable limit value GV may be input by the operation unit 36, or may be stored in advance as a standard value in a storage unit included in the control unit 35.

If the control unit 35 determines in step S3 that the absolute value of the difference EV is equal to or larger than the allowable limit value GV, step S4 in FIG. 15 is performed to adjust the pressure in the zone Z3. This is because, since it is conceivable that the pressure in the zone Z3 is outside the allowable range if the absolute value of the difference EV is equal to or larger than the allowable limit value GV, the pressure in the zone Z3 needs to be adjusted. On the other hand, if the control unit 35 determines in step S3 that the absolute value of the difference EV is smaller than the allowable limit value GV, step S4 in FIG. 15 is not performed for the zone Z3. This is because, since it is conceivable that the pressure in the zone Z3 is within the allowable range if the absolute value of the difference EV is smaller than the allowable limit value GV, there is no need to adjust the pressure in the zone Z3.

In step S4 in FIG. 15, the control unit 35 adjusts the output of the inverter 55 of the zone Z3 based on a PID control law prepared in advance such that the pressure in the zone Z3 approaches the set pressure SV.

For example, when the absolute value of the difference EV is equal to or larger than the allowable limit value GV and the difference EV is positive, the pressure in the zone Z3 is too high, so the control unit 35 increases the output of the inverter 55 of the zone Z3 such that the pressure in the zone Z3 decreases. In this way, since the rotation speed of the motor constituting the blower 54 of the zone Z3 increases, the air volume of the blower 54 of the zone Z3 increases, and as a result, the pressure in the zone Z3 decreases.

On the other hand, when the absolute value of the difference EV is equal to or larger than the allowable limit value GV and the difference EV is negative, the pressure in the zone Z3 is too low, so the control unit 35 reduces the output of the inverter 55 of the zone Z3 such that the pressure in the zone Z3 increases. In this way, since the rotation speed of the motor constituting the blower 54 of the zone Z3 decreases, the air volume of the blower 54 of the zone Z3 decreases, and as a result, the pressure in the zone Z3 increases.

Note that, since the output of the inverter 45 of the zone Z3 is not changed during the control of FIG. 15, the rotation speed of the motor constituting the blower 44 of the zone Z3 is not changed. Namely, in the control of FIG. 15, the pressure in the zone Z3 is controlled by adjusting the output of the inverter 55 of the zone Z3 according to the measured pressure PV of the zone Z3 in the state where the output of the inverter 45 of the zone Z3 is kept constant.

By repeating the control of FIG. 15, the difference EV between the measured pressure PV and the set pressure SV of the zone Z3 can be kept within the allowable range, and when the difference EV between the measured pressure PV and the set pressure SV of the zone Z3 falls outside the allowable range, it can be quickly returned within the allowable range.

FIG. 16 is a graph showing the measured pressure PV of the zone Z3 and the output of the inverter 55 of the zone Z3. In FIG. 16, the horizontal axis of each of the upper and lower graphs corresponds to elapsed time. In FIG. 16, the vertical axis of the upper graph corresponds to the measured pressure PV of the zone Z3, and the vertical axis of the lower graph corresponds to the output of the inverter 55 of the zone Z3. In addition, in the upper graph of FIG. 16, the set pressure SV of the zone Z3 is indicated by a dot-dashed line.

As can be seen from the graph in FIG. 16, when the measured pressure PV is equal to or larger than “SV+GV” and when the measured pressure PV is equal to or less than “SV−GV”, the absolute value of the difference EV between the measured pressure PV and the set pressure SV is equal to or larger than the allowable limit value GV. Therefore, during the period indicated as “output adjusting” in the graph of FIG. 16, the control of step S4 in FIG. 15 is performed to adjust the output of inverter 55 (see the lower graph in FIG. 16), whereby the absolute value of the difference EV between the measured pressure PV and the set pressure SV converges to below the allowable limit value GV (see the upper graph in FIG. 16).

By performing the control of FIG. 15 for each of the plurality of zones Z1 to Z10 of the chamber 31, the difference EV between the measured pressure PV and the set pressure SV in each of the zones Z1 to Z10 of the chamber 31 can be kept within the allowable range, and when the difference EV between the measured pressure PV and the set pressure SV in each of the zones Z1 to Z10 falls outside the allowable range, it can be quickly returned within the allowable range. In this way, it is possible to control the pressure inside the chamber 31 to a desired pressure distribution. For example, it is possible to control the pressure inside the chamber 31 to any of the pressure distributions shown in FIG. 8 to FIG. 13 above.

The control of FIG. 15 can be performed in parallel for each of the plurality of zones Z1 to Z10 of the chamber 31, or can be performed sequentially for the plurality of zones Z1 to Z10 of the chamber 31.

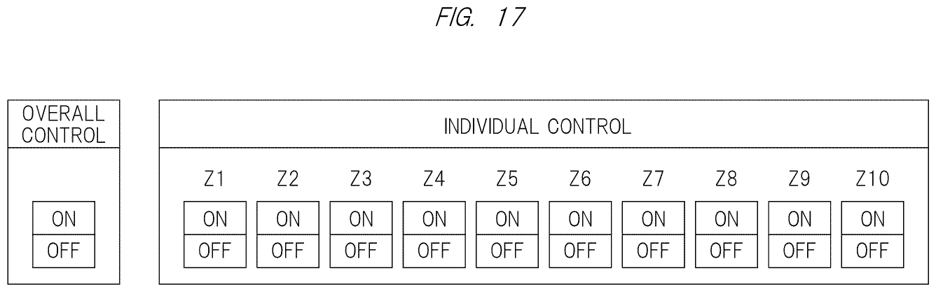

FIG. 17 is an explanatory diagram showing the operation unit configured to operate the switching of the control of FIG. 15 for the plurality of zones Z1 to Z10 of the chamber 31. The operation unit shown in FIG. 17 corresponds to a part of the operation unit 36 described above.

When the overall control button is turned on in the operation unit shown in FIG. 17, the control of FIG. 15 can be performed for each of the plurality of zones Z1 to Z10 of the chamber 31 in a specific order. For example, the control of FIG. 15 can be performed sequentially for the plurality of zones Z1 to Z10 of the chamber 31 in the order of: zone Z1, zone Z2, . . . , zone Z9, zone Z10, zone Z1, zone Z2, . . . zone Z9, zone Z10, zone Z1, zone Z2, . . . and the like.

Further, it is also possible to perform the control of FIG. 15 only for selected zones among the plurality of zones Z1 to Z10 of the chamber 31. When the individual control buttons for specific zones among the plurality of zones Z1 to Z10 are turned on in the operation unit shown in FIG. 17, the control of FIG. 15 can be performed only for the zones whose buttons have been turned on. For example, by turning on the individual control buttons for the zones Z2, Z3, Z6, 27, 29, and Z10, the control of FIG. 15 can be performed for the zones Z2, 23, 26, 27, Z9, and Z10. At this time, the control of FIG. 15 is not performed for the zones whose individual control buttons are set to the off state.

### Second Example of Method of Controlling Pressure Inside Chamber

Next, a second example of the method of controlling the pressure inside the chamber 31 will be described. The second example is a modification of the first example described above.

FIG. 18 is an explanatory diagram showing the heat treatment unit 12 of the stretching apparatus 5, and corresponds to FIG. 14 above. The case of FIG. 18 differs from the case of FIG. 14 above in the following respects.

That is, in the case of FIG. 14 above, the blower 44 and the inverter 45 for air supply and the blower 54 and the inverter 55 for exhaust are provided for each of the plurality of zones Z1 to Z10 of the chamber 31. On the other hand, in the case of FIG. 18, at least one of the plurality of zones Z1 to Z10 of the chamber 31 share the blower 54 and the inverter 55 for exhaust with other zones, and also share the blower 44 and the inverter 45 for air supply with other zones.

Specifically, in the case of FIG. 18, for the zones Z9 and Z10 of the chamber 31, the blower 44 and the inverter 45 for air supply and the blower 54 and the inverter 55 for exhaust are provided for each of the zones Z9 and Z10. Meanwhile, in the case of FIG. 18, for the zones Z1 to 28 of the chamber 31, the common blower 44 and inverter 45 for air supply and the common blower 54 and inverter 55 for exhaust are provided for every two zones.

Specifically, in the case of FIG. 18, a common blower 44a and inverter 45a for air supply and a common blower 54a and inverter 55a for exhaust are provided for the zones Z1 and Z3 of the chamber 31. Then, the common blower 44a and inverter 45a for air supply are used to supply air to both the zones Z1 and Z3, and the common blower 54a and inverter 55a for exhaust are used to exhaust air from both the zones Z1 and Z3. Similarly, a common blower 44b and inverter 45b for air supply and a common blower 54b and inverter 55b for exhaust are provided for the zones Z2 and Z4 of the chamber 31. Then, the common blower 44b and inverter 45b for air supply are used to supply air to both the zones Z2 and Z4, and the common blower 54b and inverter 55b for exhaust are used to exhaust air from both the zones Z2 and Z4. Similarly, a common blower 44c and inverter 45c for air supply and a common blower 54c and inverter 55c for exhaust are provided for the zones Z5 and Z7 of the chamber 31. Then, the common blower 44c and inverter 45c for air supply are used to supply air to both the zones Z5 and Z7, and the common blower 54c and inverter 55c for exhaust are used to exhaust air from both the zones Z5 and Z7. Similarly, a common blower 44d and inverter 45d for air supply and a common blower 54d and inverter 55d for exhaust are provided for the zones Z6 and Z8 of the chamber 31. Then, the common blower 44d and inverter 45d for air supply are used to supply air to both the zones Z6 and Z8, and the common blower 54d and inverter 55d for exhaust are used to exhaust air from both the zones Z6 and Z8.

In the case of FIG. 18, the control of FIG. 15 can be performed for each of the zones Z9 and Z10 of the chamber 31. However, the control of FIG. 15 can be performed for only one of the zones Z1 and Z3, one of the zones Z2 and Z4, one of the zones Z5 and Z7, and one of the zones Z6 and Z8. For example, for the zones Z1 and Z3, the control of FIG. 15 is performed for one of the zones (zone Z3 is assumed here), and the control of FIG. 15 is not performed for the other of the zones (zone Z1 is assumed here).

Therefore, when the control unit 35 determines in step S3 in FIG. 15 that the absolute value of the difference EV between the measured pressure PV of the zone Z3 and the set pressure SV of the zone Z3 is equal to or larger than the allowable limit value GV, step S4 in FIG. 15 is performed to adjust the pressure in the zone Z3. In this case, the pressure in the zone Z3 is controlled by adjusting the output of the inverter 55a connected to the common blower 54a for the zones Z1 and Z3 according to the measured pressure PV of the zone Z3 in the state where the output of the inverter 45a connected to the common blower 44a for the zones Z1 and Z3 is kept constant. In this way, the pressure in the zone Z3 approaches the set pressure SV of the zone Z3. However, since the blower 54a is used not only for exhausting air from the zone Z3 but also for exhausting air from the zone Z1, the pressure in the zone Z1 may also change. Therefore, it is preferable that the control of FIG. 15 is performed for the zone in which the internal pressure should be controlled preferentially (for example, zone Z3), out of the zones Z1 and Z3.

In the case of FIG. 14 (first example), since the pressure in each of the plurality of zones Z1 to Z10 of the chamber 31 can be controlled independently, the pressure distribution in the chamber 31 can be controlled more precisely.

On the other hand, in the case of FIG. 18 (second example), the necessary numbers of blowers 44 and 54 and inverters 45 and 55 can be reduced. Therefore, the structure of the stretching apparatus 5 can be simplified, and the stretching apparatus 5 can be made smaller in size. In addition, the manufacturing cost of the stretching apparatus 5 can be reduced.

### Third Example of Method of Controlling Pressure Inside Chamber

Next, a third example of the method of controlling the pressure inside the chamber 31 will be described. The third example is a further modification of the second example.

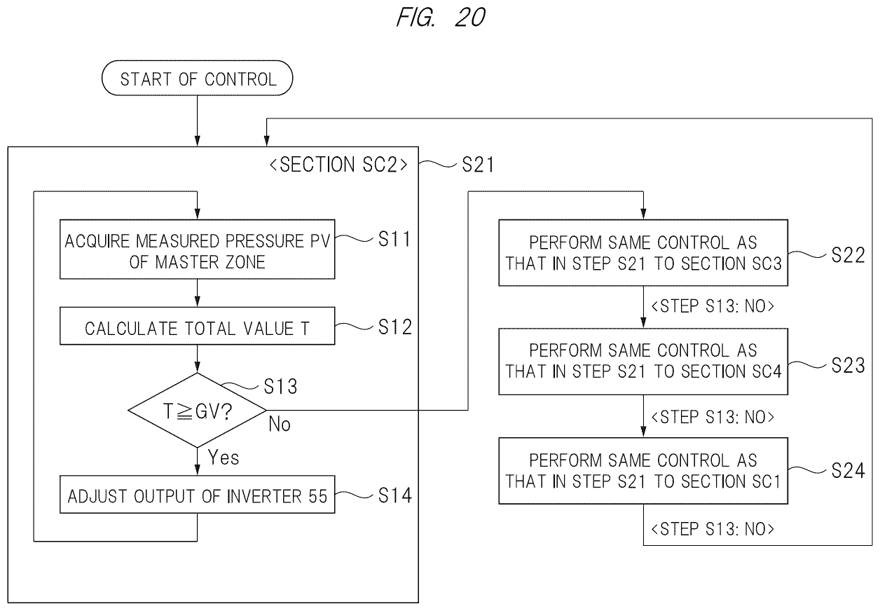

FIG. 19 is an explanatory diagram showing the heat treatment unit 12 of the stretching apparatus 5, and corresponds to FIG. 18 above. In the case of FIG. 19, the air supply unit 32 is the same as that in FIG. 18 above, and illustration of the air supply unit 32 (air supply port 41, air supply pipe 42, blower 44, and inverter 45) is omitted for simplification. FIG. 20 is a flow diagram showing pressure control. The case of FIG. 19 differs from the case of FIG. 18 above in the following respects.

In the case of FIG. 19, of the plurality of zones Z1 to Z10 of the chamber 31, the zones Z1, Z2, Z3, and Z4 are treated as a section SC1, the zones Z5, Z6, Z7, and Z8 are treated as a section SC2, the zone Z9 is treated as a section SC3, and the zone Z10 is treated as a section SC4. It is preferable that the zones Z1, Z2, Z3, and Z4 constituting the same section SC1 have the same set pressure SV. Similarly, it is preferable that the zones Z5, Z6, Z7, and Z8 constituting the same section SC2 have the same set pressure SV.

In the case of FIG. 19 as well, the air supply unit 32 (air supply port 41, air supply pipe 42, blower 44, and inverter 45) and the exhaust unit 33 (exhaust port 51, exhaust pipe 52, damper 53, blower 54, and inverter 55) are the same as those in FIG. 18 above, so repetitive descriptions thereof will be omitted here.

In the case of FIG. 19 and FIG. 20, the chamber 31 is divided into a plurality of sections SC1, SC2, SC3, and SC4, and pressure control is performed for each section.

First, the pressure control of step S21 in FIG. 20 is performed to a certain section, the section SC2 here, of the plurality of sections SC1, SC2, SC3, and SC4. The pressure control of step S21 in FIG. 20 is as follows.

First, the control unit 35 acquires the measured pressure PV of each master zone in the section SC2 that is the target of step S21 (step S11 in FIG. 20). The measured pressure PV can be acquired by measuring the pressure in the master zone by the pressure measuring unit 34 provided in the master zone.

Here, the master zone corresponds to a zone in which pressure can be controlled by the exhaust blower 54. Therefore, when one exhaust blower 54 is used to exhaust air from only one zone, that zone corresponds to the master zone. Also, when one common exhaust blower 54 is used to exhaust air from two zones, one of the two zones corresponds to the master zone. Specifically, one of the two zones Z1 and Z3 (zone Z3 is assumed here) from which air is exhausted by the common exhaust blower 54a and one of the two zones Z2 and Z4 (zone Z2 is assumed here) from which air is exhausted by the common exhaust blower 54b correspond to the master zones in the section SC1. Also, one of the two zones Z5 and Z7 (zone Z7 is assumed here) from which air is exhausted by the common exhaust blower 54c and one of the two zones Z6 and Z8 (zone Z6 is assumed here) from which air is exhausted by the common exhaust blower 54d correspond to the master zones in the section SC2. Further, the master zone in the section SC3 corresponds to the zone Z9, and the master zone in the section SC4 corresponds to the zone Z10. In FIG. 19, the master zones are indicated as “MST”.

After step S11, the control unit 35 calculates the square of the difference EV between the measured pressure PV and the set pressure SV in each master zone (zones Z6 and Z7 in this case) of the section SC2, and calculates the total value T thereof (step S12 in FIG. 20). Here, if the square of the difference EV between the measured pressure PV and the set pressure SV in the zone Z6 is expressed as (EV6)² and the square of the difference EV between the measured pressure PV and the set pressure SV in the zone Z7 is expressed as (EV7)², the total value T in the section SC2 can be expressed as T=(EV6)²+ (EV7)².

After step S12, the control unit 35 compares the total value T calculated in step S12 with a predetermined allowable limit value GV (step S13 in FIG. 20). If it is determined in step S13 that the total value T in the section SC2 is equal to or larger than the allowable limit value GV (that is, T≥GV), step S14 in FIG. 20 is performed to adjust the pressure in the section SC2. This is because it is conceivable that the pressure in the section SC2 is outside the allowable range if the total value T is equal to or larger than the allowable limit value GV. On the other hand, if it is determined in step S13 that the total value T in the section SC2 is smaller than the allowable limit value GV (that is, T<GV), step S14 in FIG. 20 is not performed for the section SC2. This is because it is conceivable that the pressure in the section SC2 is within the allowable range if the total value T is smaller than the allowable limit value GV.

In step S14 in FIG. 20, the control unit 35 adjusts the output of the inverters 55 (here, inverters 55c and 55d) connected to the blowers 54 (here, blowers 54c and 54d) for the section SC2 based on the PID control law prepared in advance such that the pressure (internal pressure) in the master zone of the section SC2 approaches the set pressure SV.

For example, when the pressure in the master zone of the section SC2 is too high, the output of the inverters 55 (here, inverters 55c and 55d) connected to the blowers 54 (here, blowers 54c and 54d) for the section SC2 is increased such that the pressure in the section SC2 decreases. In this way, since the rotation speed of the motor constituting the blower 54 for the section SC2 increases, the air volume of the blower 54 for the section SC2 increases, and as a result, the pressure in the section SC2 (that is, zones Z5, Z6, Z7, and Z8) decreases.

On the other hand, when the pressure in the master zone of the section SC2 is too low, the output of the inverters 55 (here, inverters 55c and 55d) connected to the blowers 54 (here, blowers 54c and 54d) for the section SC2 is reduced such that the pressure in the section SC2 increases. In this way, since the rotation speed of the motor constituting the blower 54 for the section SC2 decreases, the air volume of the blower 54 for the section SC2 decreases, and as a result, the pressure in the section SC2 (that is, zones Z5, Z6, Z7, and Z8) increases. Note that, in step S21 in FIG. 20, the output of the inverter 45 connected to each air supply blower 44 is kept constant.

As described above, in step S21 in FIG. 20, the output of the inverters 55 (here, inverters 55c and 55d) connected to the blowers 54 (here, blowers 54c and 54d) for the section SC2 is adjusted according to the measured pressure PV of each master zone (here, zones Z6 and Z7) of the section SC2, whereby the pressure in the section SC2 (that is, zones Z5, Z6, Z7, and Z8) is controlled.

Steps S11, S12, S13, and S14 are repeated for the section SC2 until it is determined in step S13 that the total value T in the section SC2 is smaller than the allowable limit value GV (that is, T<GV). When it is determined in step S13 that the total value T in the section SC2 is smaller than the allowable limit value GV (that is, T<GV), the control of step S21 for the section SC2 is finished, and the control of step S22 in FIG. 20 is performed for the section SC3.

In step S22 in FIG. 20, the same control as that in step S21 described above (that is, steps S11, S12, S13, and S14) is performed to the section SC3. However, the master zone is the zone Z9 in the section SC3. Therefore, in step S11 in step S22 in FIG. 20, the measured pressure PV of the zone Z9 which is the master zone of the section SC3 is acquired. Also, in step S14 in step S22 in FIG. 20, the control unit 35 adjusts the output of the inverter 55 connected to the blower 54 for the section SC3 such that the pressure in the zone Z9 which is the master zone of the section SC3 approaches the set pressure SV.

In step S22, steps S11, S12, S13, and S14 are repeated for the section SC3 until it is determined in step S13 that the total value T in the section SC3 is smaller than the allowable limit value GV (that is, T<GV). When it is determined in step S13 in step S22 that the total value T in the section SC3 is smaller than the allowable limit value GV (that is, T<GV), the control of step S22 for the section SC3 is finished, and the control of step S23 in FIG. 20 is performed for the section SC4.

In step S23 in FIG. 20, the same control as that in step S21 described above (that is, steps S11, S12, S13, and $14) is performed to the section SC4. However, the master zone is the zone Z10 in the section SC4. Therefore, in step S11 in step S23 in FIG. 20, the measured pressure PV of the zone Z10 which is the master zone of the section SC4 is acquired. Also, in step S14 in step S23 in FIG. 20, the control unit 35 adjusts the output of the inverter 55 connected to the blower 54 for the section SC4 such that the pressure in the zone Z10 which is the master zone of the section SC4 approaches the set pressure SV.

In step S23, steps S11, S12, S13, and S14 are repeated for the section SC4 until it is determined in step S13 that the total value T in the section SC4 is smaller than the allowable limit value GV (that is, T<GV). When it is determined in step S13 in step S23 that the total value T in the section SC4 is smaller than the allowable limit value GV (that is, T<GV), the control of step S23 for the section SC4 is finished, and the control of step S24 in FIG. 20 is performed for the section SC1.

In step S24 in FIG. 20, the same control as that in step S21 described above (that is, steps S11, S12, S13, and S14) is performed to the section SC1. However, the master zones are the zones Z2 and Z3 in the section SC1. Therefore, in step S11 in step S24 in FIG. 20, the measured pressures PV of the zones Z2 and Z3 which are the master zones of the section SC1 are acquired. Also, in step S14 in step S24 in FIG. 20, the control unit 35 adjusts the output of the inverters 55 (here, inverters 55a and 55b) connected to the blowers 54 (here, blowers 54a and 54b) for the section SC1 such that the pressures in the zones Z2 and Z3 which are the master zones of the section SC1 approach the set pressures SV.

In step S24, steps S11, S12, S13, and S14 are repeated for the section SC1 until it is determined in step S13 that the total value T in the section SC1 is smaller than the allowable limit value GV (that is, T<GV). When it is determined in step S13 in step S24 that the total value T in the section SC1 is smaller than the allowable limit value GV (that is, T<GV), the control of step S24 for the section SC1 is finished, and the control of step S21 in FIG. 20 is performed for the section SC2.

The control of step S21 for the section SC2, the control of step S22 for the section SC3, the control of step S23 for the section SC4, and the control of step S24 for the section SC1 are repeated in this order. In this way, the pressure in each of the sections SC1, SC2, SC3, and SC4 can be kept within the respective allowable ranges, and when the pressure in each of the sections SC1, SC2, SC3, and SC4 falls outside the allowable range, it can be quickly returned within the allowable range.

In the case of FIG. 20 (third example), the section SC2 which includes the plurality of zones Z5, Z6, Z7, and Z8 is controlled collectively in step S21, and the section SC1 which includes the plurality of zones Z1, Z2, Z3, and Z4 is controlled collectively in step S24. Therefore, the time required for control can be shortened in the case of FIG. 20 (third example) in comparison with the case of controlling the zones Z1, Z2, Z3, Z4, Z5, Z6, Z7, Z8, Z9, and Z10 in sequence. Accordingly, when the measured pressure fluctuates for some reason, the pressure inside the chamber can be corrected more quickly to converge to within the allowable range.

### Second Embodiment

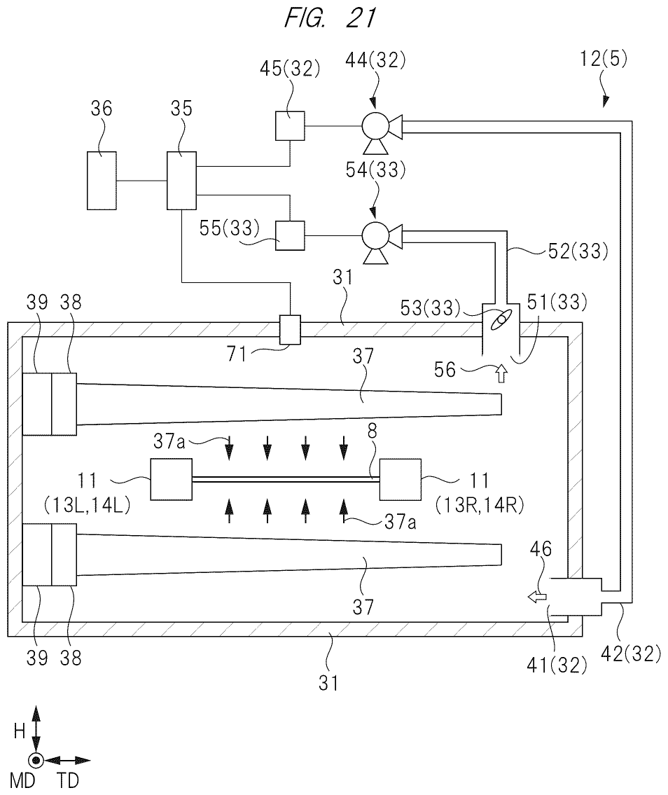

FIG. 21 is a cross-sectional view of the heat treatment unit 12 of the stretching apparatus 5 according to the second embodiment, and shows a cross section corresponding to FIG. 5 above.

In the second embodiment, the heat treatment unit 12 of the stretching apparatus 5 includes a temperature measuring unit 71 instead of the pressure measuring unit 34. Namely, in the second embodiment, the chamber 31 is provided with the temperature measuring unit 71 capable of measuring the temperature inside the chamber 31. Specifically, the temperature measuring unit 71 is, for example, a thermometer or a temperature sensor.

The temperature inside the chamber 31 is specified mainly by the temperature of the heated air ejected from the nozzle 37, but can also be controlled by adjusting the exhaust rate of the chamber 31 from the exhaust port 51 of the exhaust unit 33. Namely, the heated air ejected from the plurality of holes of the nozzle 37 circulates within the chamber 31, is heated again by the heater 38, and is ejected from the plurality of holes of nozzle 37, but a part of the heated air in the chamber 31 is exhausted to the outside of the chamber 31 from the exhaust port 51. Since the temperature of the heated air exhausted from the exhaust port 51 is higher than the temperature of the air supplied into the chamber 31 from the air supply port 41 of the air supply unit 32, increasing the exhaust rate of the heated air in the chamber 31 from the exhaust port 51 lowers the temperature inside the chamber 31. Therefore, the temperature inside the chamber 31 can be controlled by adjusting the air volume of the exhaust blower 54. Specifically, since the exhaust rate of the heated air in the chamber 31 from the exhaust port 51 increases when the air volume of the exhaust blower 54 increases, the temperature inside the chamber 31 decreases, and since the exhaust rate of the heated air in the chamber 31 from the exhaust port 51 decreases when the air volume of the exhaust blower 54 decreases, the temperature inside the chamber 31 increases.

In the second embodiment, the temperature measuring unit 71 can measure the temperature inside the chamber 31, and the control unit 35 can control the temperature inside the chamber 31 by adjusting the air volume of the exhaust blower 54 based on the temperature measured by the temperature measuring unit 71. Specifically, the control unit 35 can control the temperature inside the chamber 31 by adjusting the output from the inverter 55 to the exhaust blower 54 based on the temperature measured by the temperature measuring unit 71 to adjust the air volume of the exhaust blower 54. When the output from the inverter 55 to the blower 54 is increased, the air volume of the exhaust blower 54 increases, and the temperature inside the chamber 31 decreases. Further, when the output from the inverter 55 to the blower 54 is reduced, the air volume of the exhaust blower 54 decreases, and the temperature inside the chamber 31 increases. Therefore, when the control unit 35 determines that the temperature measured by the temperature measuring unit 71 is outside the allowable range, it adjusts the output from the inverter 55 to the exhaust blower 54 such that the temperature inside the chamber 31 is within the allowable range, whereby the temperature inside the chamber 31 can be adjusted to the desired temperature.

Also, the air volume of the blower 54 can also be adjusted by adjusting the opening/closing degree of the damper 53. Therefore, as another embodiment, the control unit 35 can also control the temperature inside the chamber 31 by adjusting the opening/closing degree of the damper 53 based on the temperature measured by the temperature measuring unit 71 to adjust the air volume of the exhaust blower 54. The air volume of the exhaust blower 54 increases and the temperature inside the chamber 31 decreases when the opening degree of the damper 53 is increased, and the air volume of the exhaust blower 54 decreases and the temperature inside the chamber 31 increases when the opening degree of the damper 53 is decreased. As still another embodiment, it is also possible to adjust both the output of the inverter 55 and the opening/closing degree of the damper 53 based on the temperature measured by the temperature measuring unit 71.

In the second embodiment, it is possible to solve or suppress the problems that may occur when the temperature inside the chamber 31 falls outside the allowable range. For example, when an accompanying flow is generated in the chamber 31 as the film 8 advances, the temperature is likely to fluctuate in the vicinity of the film 8. In order to suppress temperature fluctuations in the vicinity of the film 8, it is effective to maintain the temperature inside the chamber 31 within the allowable temperature range. In the second embodiment, since the temperature inside the chamber 31 can be controlled by adjusting the air volume of the exhaust blower 54 based on the temperature measured by the temperature measuring unit 71, the temperature inside the chamber 31 can be quickly and accurately controlled to the desired temperature. In this way, it is possible to suppress the temperature fluctuations in the chamber 31 when the accompanying flow is generated, and the properties of the film after the stretching process can be made uniform.

Also, the method of controlling the temperature inside the chamber 31 can be performed in the same manner as the example of the method of controlling the pressure inside the chamber 31 described in the first embodiment above.

For example, the case in which the first example in FIG. 14 and FIG. 15 above is applied to the second embodiment will be described. In this case, the temperature measuring unit 71 is provided instead of the pressure measuring unit 34 in each of the zones Z1 to Z10 (FIG. 14) of the chamber 31, and the set pressure SV described above becomes the set temperature, and the measured pressure PV described above becomes the measured temperature measured by the temperature measuring unit 71 in FIG. 15. The temperature of each of the zones Z1 to Z10 can be measured by the temperature measuring unit 71 provided in each of the zones Z1 to Z10.

Specifically, in the control of FIG. 15 in the case of the second embodiment, the temperature of the target zone of the zones Z1 to Z10 is measured by the temperature measuring unit 71 provided in the target zone, and the control unit 35 acquires the measured temperature instead of the measured pressure PV described above in step S1 in FIG. 15. In step S2 in FIG. 15, the control unit 35 calculates the difference between the measured temperature acquired in step S1 and the set temperature of the target zone. In step S3 in FIG. 15, the control unit 35 compares the absolute value of the difference calculated in step S2 with a predetermined allowable limit value. Since it is conceivable that the temperature of the target zone is outside the allowable range when the control unit 35 determines that the absolute value of the difference calculated in step S2 is equal to or larger than the allowable limit value in step S3, step S4 in FIG. 15 is performed to adjust the temperature of the target zone. On the other hand, since it is conceivable that the temperature of the target zone is within the allowable range when it is determined that the absolute value of the difference calculated in step S2 is smaller than the allowable limit value, step S4 in FIG. 15 is not performed for the target zone. In step S4 in FIG. 15, the control unit 35 adjusts the output of the inverter 55 in the target zone based on the PID control law prepared in advance such that the temperature in the target zone approaches the set temperature. Since the rotation speed of the motor constituting the blower 54 in the target zone increases when the output of the inverter 55 in the target zone is increased, the air volume of the blower 54 in the target zone increases, and the temperature in the target zone decreases. Since the rotation speed of the motor constituting the blower 54 in the target zone decreases when the output of the inverter 55 in the target zone is reduced, the air volume of the blower 54 in the target zone decreases, and the temperature in the target zone increases. By repeating the control of FIG. 15 above, the difference between the measured temperature and the set temperature of the target zone can be kept within the allowable range, and when the difference between the measured temperature and the set temperature of the target zone falls outside the allowable range, it can be quickly returned within the allowable range.

In addition, it is also possible to apply the second example in FIG. 18 and FIG. 15 above to the second embodiment. In this case, the temperature measuring unit 71 is provided instead of the pressure measuring unit 34 in each of the zones Z1 to Z10 (FIG. 18) of the chamber 31, and the set pressure SV described above becomes the set temperature, and the measured pressure PV described above becomes the measured temperature measured by the temperature measuring unit 71 in FIG. 15 above.

Further, it is also possible to apply the third example in FIG. 19 and FIG. 20 above to the second embodiment. In this case, the temperature measuring unit 71 is provided instead of the pressure measuring unit 34 in each of the zones Z1 to Z10 (FIG. 19) of the chamber 31, and the measured pressure PV described above becomes the measured temperature measured by the temperature measuring unit 71 in FIG. 20 above.

### Third Embodiment

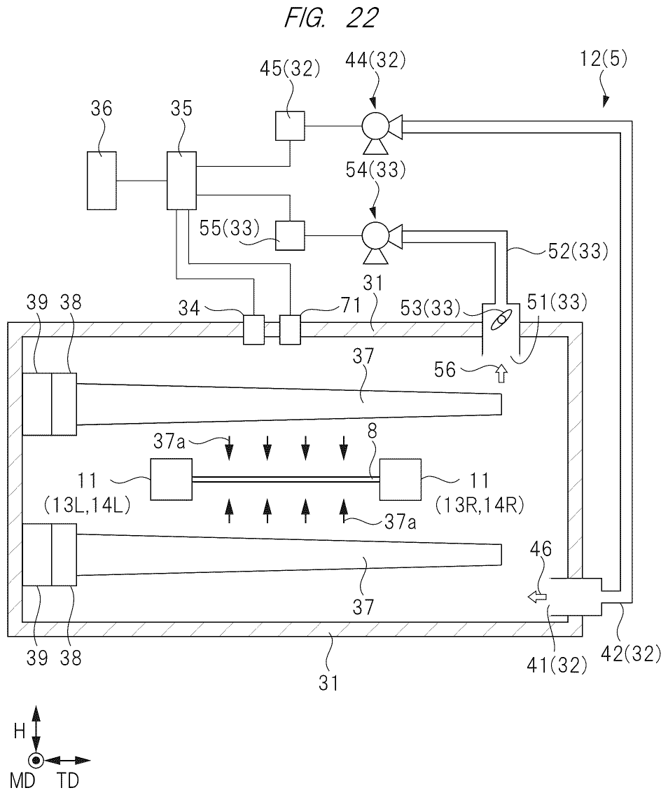

FIG. 22 is a cross-sectional view of the heat treatment unit 12 of the stretching apparatus 5 according to the third embodiment, and shows a cross section corresponding to FIG. 5 and FIG. 21 above.

The third embodiment corresponds to a combination of the first and second embodiments described above. Therefore, in the third embodiment, the heat treatment unit 12 of the stretching apparatus 5 has both the pressure measuring unit 34 and the temperature measuring unit 71. Namely, in the third embodiment, the chamber 31 is provided with the pressure measuring unit 34 capable of measuring the pressure inside the chamber 31 and the temperature measuring unit 71 capable of measuring the temperature inside the chamber 31. Accordingly, in the case of the third embodiment, both the pressure measuring unit 34 and the temperature measuring unit 71 can be provided in each of the zones Z1 to Z10 (FIG. 14, FIG. 18, and FIG. 19) of the chamber 31.

In the third embodiment, the pressure measuring unit 34 can measure the pressure inside the chamber 31, the temperature measuring unit 71 can measure the temperature inside the chamber 31, and the control unit 35 can control the pressure and temperature inside the chamber 31 by adjusting the air volume of the exhaust blower 54 based on the pressure measured by the pressure measuring unit 34 and the temperature measured by the temperature measuring unit 71. Specifically, the control unit 35 can control the temperature inside the chamber 31 by adjusting the output from the inverter 55 to the exhaust blower 54 based on the pressure measured by the pressure measuring unit 34 and the temperature measured by the temperature measuring unit 71 to adjust the air volume of the exhaust blower 54. Therefore, when the control unit 35 determines that the pressure measured by the pressure measuring unit 34 and/or the temperature measured by the temperature measuring unit 71 are outside the allowable ranges, it adjusts the output from the inverter 55 to the exhaust blower 54 such that the pressure and temperature inside the chamber 31 are within the allowable range, whereby the pressure and temperature inside the chamber 31 can be controlled to the desired pressure and temperature. Further, as another embodiment, the control unit 35 can control the pressure and temperature inside the chamber 31 by adjusting the opening/closing degree of the damper 53 (or by adjusting both the output of the inverter 55 and the opening/closing degree of the damper 53) based on the pressure measured by the pressure measuring unit 34 and the temperature measured by the temperature measuring unit 71 to adjust the air volume of the exhaust blower 54.

In the third embodiment, it is possible to solve or suppress the problems that may occur when one or both of the pressure and temperature inside the chamber 31 are outside the allowable ranges.

In the foregoing, the invention made by the inventors of this application has been specifically described based on the embodiments. However, it is needless to say that the present invention is not limited to the foregoing embodiments and various modifications can be made within the range not departing from the gist thereof.

For example, in the first to third embodiments described above, the case in which a transverse stretching apparatus configured to perform the stretching process to the film 8 in the transverse direction (TD direction) is used as the stretching apparatus 5 has been described as an example. However, as another embodiment, the technical idea of the first to third embodiments described above can also be applied to the case in which a biaxial stretching apparatus capable of simultaneously stretching the film 8 in both the MD direction (longitudinal direction) and the TD direction (transverse direction) is used.

### REFERENCE SIGNS LIST

1 thin-film manufacturing system
2 extrusion apparatus
2a raw material supply unit
3 T-die
4 raw sheet cooling apparatus
5 stretching apparatus
6 take-off apparatus
7 winder apparatus
8 film
11 conveying device
12 heat treatment unit
13, 13L, 13R clip
14L, 14R guide rail
20A, 20B, 20C region
31 chamber
32 air supply unit
33 exhaust unit
34 pressure measuring unit
35 control unit
37 nozzle
38 heater
39 blower fan
41 air supply port
42 air supply pipe
44 blower
45 inverter
51 exhaust port
52 exhaust pipe
53 damper
54 blower
55 inverter
71 temperature measuring unit
SC1, SC2, SC3, SC4 section
Z1, Z2, Z3, Z4, Z5, Z6, Z7, Z8, Z9, Z10 zone

1. A stretching apparatus of a thermoplastic resin film comprising:
a conveying device configured to convey and stretch the thermoplastic resin film; and
a heat treatment unit configured to perform a heat treatment to the thermoplastic resin film,
wherein the heat treatment unit includes:
a chamber configured to cover the conveying device;
an air supply unit configured to supply air into the chamber;
an exhaust unit configured to exhaust air from the chamber;
a pressure measuring unit configured to measure a pressure inside the chamber; and
a control unit,
wherein the exhaust unit has an exhaust port provided in the chamber and an exhaust blower capable of exhausting air through the exhaust port, and
wherein the control unit controls the pressure inside the chamber by adjusting an air volume of the exhaust blower based on the pressure measured by the pressure measuring unit.

2. The stretching apparatus according to claim 1,
wherein the exhaust unit further has an inverter connected to the exhaust blower, and
wherein the control unit controls the pressure inside the chamber by adjusting an output from the inverter to the exhaust blower based on the pressure measured by the pressure measuring unit to adjust the air volume of the exhaust blower.

3. The stretching apparatus according to claim 2,
wherein, when the control unit determines that the pressure measured by the pressure measuring unit is outside an allowable range, it adjusts the output from the inverter to the exhaust blower such that the pressure inside the chamber is within the allowable range.

4. The stretching apparatus according to claim 1,
wherein the exhaust unit further has an exhaust pipe provided between the exhaust blower and the exhaust port and a damper provided in a middle of the exhaust pipe, and
wherein the control unit controls the pressure inside the chamber by adjusting an opening/closing degree of the damper based on the pressure measured by the pressure measuring unit to adjust the air volume of the exhaust blower.

5. The stretching apparatus according to claim 1,
wherein the air supply unit has an air supply port provided in the chamber and an air supply blower capable of supplying air into the chamber through the air supply port.

6. The stretching apparatus according to claim 1,
wherein the chamber has a plurality of zones arranged in a conveying direction of the thermoplastic resin film, and
wherein the air supply unit, the exhaust unit, and the pressure measuring unit are provided for each of the plurality of zones.

7. The stretching apparatus according to claim 6,
wherein the exhaust unit further has an inverter connected to the exhaust blower, and
wherein the control unit controls the pressure inside the chamber by adjusting an output from the inverter to the exhaust blower based on the pressure measured by the pressure measuring unit to adjust the air volume of the exhaust blower in one or more selected zones among the plurality of zones.

8. The stretching apparatus according to claim 7,
wherein, when the control unit determines that the pressure measured by the pressure measuring unit is outside an allowable range in one or more selected zones among the plurality of zones, it adjusts the output from the inverter to the exhaust blower such that the pressure inside the chamber is within the allowable range.

9. The stretching apparatus according to claim 6,
wherein the exhaust unit further has an inverter connected to the exhaust blower, and
wherein the control unit controls the pressure inside the chamber by adjusting an output from the inverter to the exhaust blower based on the pressure measured by the pressure measuring unit to adjust the air volume of the exhaust blower in each of the plurality of zones.

10. The stretching apparatus according to claim 9,
wherein, when the control unit determines that the pressure measured by the pressure measuring unit is outside an allowable range in each of the plurality of zones, it adjusts the output from the inverter to the exhaust blower such that the pressure inside the chamber is within the allowable range.

11. The stretching apparatus according to claim 6,
wherein the exhaust unit further has an inverter connected to the exhaust blower, and
wherein at least one or more zones of the plurality of zones share the exhaust blower and the inverter with other zones.

12. The stretching apparatus according to claim 1,
wherein the chamber has an inlet t through which the thermoplastic resin film is conveyed thereinto and an outlet through which the thermoplastic resin film is conveyed therefrom, and
wherein the control unit controls the pressure inside the chamber such that the pressure inside the chamber is higher than a pressure outside the chamber and the pressure inside the chamber becomes higher as advancing from an inlet side to an outlet side.

13. The stretching apparatus according to claim 1,
wherein the chamber has an inlet through which the thermoplastic resin film is conveyed thereinto and an outlet through which the thermoplastic resin film is conveyed therefrom, and
wherein the control unit controls the pressure inside the chamber such that the pressure inside the chamber is higher than a pressure outside the chamber and the pressure inside the chamber is higher at a center than those on inlet and outlet sides.

14. The stretching apparatus according to claim 1,
wherein the chamber has an inlet through which the thermoplastic resin film is conveyed thereinto and an outlet through which the thermoplastic resin film is conveyed therefrom, and
wherein the control unit controls the pressure inside the chamber such that the pressure inside the chamber is lower than a pressure outside the chamber and the pressure inside the chamber is lower at a center than those on inlet and outlet sides.

15. The stretching apparatus according to claim 1,
wherein the heat treatment unit further has a temperature measuring unit configured to measure a temperature inside the chamber, and
wherein the control unit controls the pressure and temperature inside the chamber by adjusting the air volume of the exhaust blower based on the pressure measured by the pressure measuring unit and the temperature measured by the temperature measuring unit.

16. A stretching apparatus of a thermoplastic resin film comprising:
a conveying device configured to convey and stretch the thermoplastic resin film; and
a heat treatment unit configured to perform a heat treatment to the thermoplastic resin film,
wherein the heat treatment unit includes:
a chamber configured to cover the conveying device;
an air supply unit configured to supply air into the chamber;
an exhaust unit configured to exhaust air from the chamber;
a temperature measuring unit configured to measure a temperature inside the chamber; and
a control unit,
wherein the exhaust unit has an exhaust port provided in the chamber and an exhaust blower capable of exhausting air through the exhaust port, and
wherein the control unit controls the temperature inside the chamber by adjusting an air volume of the exhaust blower based on the temperature measured by the temperature measuring unit.

17. The stretching apparatus according to claim 16,
wherein the exhaust unit further has an inverter connected to the exhaust blower, and
wherein the control unit controls the temperature inside the chamber by adjusting an output from the inverter to the exhaust blower based on the temperature measured by the temperature measuring unit to adjust the air volume of the exhaust blower.

18. The stretching apparatus according to claim 17,
wherein, when the control unit determines that the temperature measured by the temperature measuring unit is outside an allowable range, it adjusts the output from the inverter to the exhaust blower such that the temperature inside the chamber is within the allowable range.

19. The stretching apparatus according to claim 16,
wherein the exhaust unit further has an exhaust pipe provided between the exhaust blower and the exhaust port and a damper provided in a middle of the exhaust pipe, and
wherein the control unit controls the temperature inside the chamber by adjusting an opening/closing degree of the damper based on the temperature measured by the temperature measuring unit to adjust the air volume of the exhaust blower.

20. The stretching apparatus according to claim 16,
wherein the air supply unit has an air supply port provided in the chamber and an air supply blower capable of supplying air into the chamber through the air supply port.

21. The stretching apparatus according to claim 16,
wherein the chamber has a plurality of zones arranged in a conveying direction of the thermoplastic resin film, and
wherein the air supply unit, the exhaust unit, and the temperature measuring unit are provided for each of the plurality of zones.
